(19) United States
(12) Patent Application Publication
(10) Pub. No.: US 2025/0125411 A1
(43) Pub. Date: Apr. 17, 2025

(54) TRANSLUCENT AND TRANSPARENT SEPARATORS

(71) Applicant: QuantumScape Battery, Inc., San Jose, CA (US)

(72) Inventors: Cheng-Chieh CHAO, San Jose, CA (US); Zhebo CHEN, San Jose, CA (US); Lei CHENG, San Jose, CA (US); Niall DONNELLY, San Jose, CA (US); Timothy HOLME, San Jose, CA (US); Tommy HUANG, San Jose, CA (US); Sriram IYER, San Jose, CA (US); Kian KERMAN, San Jose, CA (US); Harsh MAHESHWARI, San Jose, CA (US); Jagdeep SINGH, San Jose, CA (US); Gengfu XU, San Jose, CA (US)

(21) Appl. No.: 18/905,740

(22) Filed: Oct. 3, 2024

Related U.S. Application Data
(63) Continuation of application No. 17/477,313, filed on Sep. 16, 2021, now Pat. No. 12,142,727.
Application No. 17/477,313 is a continuation of application No. 16/320,072, filed on Jan. 23, 2019, now Pat. No. 11,158,880.
(60) Provisional application No. 62/371,640, filed on Aug. 5, 2016.

(51) Int. Cl. H01M 10/0562; H01M 10/052; H01M 10/0525

(52) U.S. Cl. CPC H01M 10/0562; H01M 10/052; H01M 10/0525; H01M 2300/0068; H01M 2300/0071; H01M 2300/008; H01M 2300/0091

(57) ABSTRACT

Provided herein are defect-free solid-state separators which are useful as Li⁺ ion-conducting electrolytes in electrochemical cells and devices, such as, but not limited to, rechargeable batteries. In some examples, the separators have a Li⁺ ion-conductivity greater than 1*10⁻³ S/cm at room temperature.

### CROSS-REFERENCE TO RELATED APPLICATIONS

This application is a continuation of U.S. patent application Ser. No. 17/477,313, filed on Sep. 16, 2021, which is a Continuation of U.S. patent application Ser. No. 16/320,072, filed on Jan. 23, 2019, which issued as U.S. Pat. No. 11,158,880 B2 on Oct. 26, 2021; is a US national phase entry of International Patent Application No. PCT/US2017/045635, filed on Aug. 4, 2017, titled TRANSLUCENT AND TRANSPARENT SEPARATORS, which claims priority to U.S. Provisional Patent Application No. 62/371,640, filed Aug. 5, 2016. The entire contents of the above listed applications are herein incorporated by reference in their entirety for all purposes.

### FIELD

The present disclosure concerns solid electrolytes suitable for use in electrochemical cells and devices.

### BACKGROUND

In a rechargeable Li⁺ ion battery, Li⁺ ions move from a negative electrode to a positive electrode during discharge and in the opposite direction during charge. This process produces electrical energy (Energy=Voltage×Current) in a circuit connecting the electrodes, which is electrically insulated from, but parallel to, the Li⁺ ion conduction path. The battery's voltage (V versus Li) is a function of the chemical potential difference for Li situated in the positive electrode as compared to the negative electrode and is maximized when Li metal is used as the negative electrode. An electrolyte physically separates and electrically insulates the positive and negative electrodes while also providing a conduction medium for Li⁺ ions. The electrolyte ensures that when Li metal oxidizes at the negative electrode during discharge (e.g., Li⇄Li⁺+e⁻) and produces electrons, these electrons conduct between the electrodes by way of an external circuit which is not the same pathway taken by the Li⁺ ions.

Conventional rechargeable batteries use liquid electrolytes to separate the positive and negative electrodes. However, liquid electrolytes suffer from several problems including flammability during thermal runaway, outgassing at high voltages, and chemical incompatibility with lithium metal negative electrodes. As an alternative, solid electrolytes have been proposed for next generation rechargeable batteries. For example, Li⁺ ion-conducting ceramic oxides, such as lithium-stuffed garnets, have been considered as electrolyte separators. See, for example, US Patent Application Publication No. 2015/0099190, published Apr. 9, 2015, and filed Oct. 7, 2014, titled GARNET MATERIALS FOR LI SECONDARY BATTERIES AND METHODS OF MAKING AND USING GARNET MATERIALS; U.S. Pat. Nos. 8,658,317; 8,092,941; and 7,901,658; also U.S. Patent Application Publication Nos. 2013/0085055; 2011/0281175; 2014/0093785; and 2014/0170504; also Bonderer, et al. “Free-Standing Ultrathin Ceramic Foils,” Journal of the American Ceramic Society, 2010, 93(11): 3624-3631; and Murugan, et al., Angew Chem. Int. Ed. 2007, 46, 7778-7781), the entire contents of each of these publications are incorporated by reference in its entirety for all purposes.

Solid electrolytes tend to reduce a battery's total weight and volume, when compared to a liquid electrolyte, and thereby increase its gravimetric and volumetric energy density. Despite these advantages, solid electrolytes are still insufficient in several regards for commercial applications. Notably, solid electrolytes tend to include defects, pores, vacancies, uneven or rough surfaces, and other inhomogeneous, non-uniform features which may correlate with the formation of Li-dendrites, when these electrolytes are used in electrochemical cells. A challenge in the relevant field has been to prepare such solid electrolytes absent the aforementioned defects which conduct Li⁺ ions without producing Li-dendrites.

Some solid separators are known and some separators are made with some techniques which tend to reduce the number of defects in these separators. See, for example, Kotobuki, M. et. al. Int. J. Electroact. Mater. 2 (2014) 17-21; Ahmad, M. M. Nanoscale Research Letters, doi: 10.1186/s11671-015-0777-7; Baek, S-W, et al.; Journal of Power Sources 249 (2014) 197-206; Botros, M. et al., Journal of Power Sources 309 (2016) 108e115; Zhang, Y. et al., Journal of Power Sources 268 (2014) 960-964; and Zhang, Y. et al., Solid State Ionics 284 (2015) 53-60. See, also Suzuki, et al., SOLID STATE IONICS 278 (2015) 172-176; www.ikts.fraunhofer.de/content/dam/ikts/en/images/publications/jahresberichtel/jb2013/11_3_Gelcasting _-_ A_shapeing_method_for_particularly_defect-free_ceramic_parts.pdf; and J. Ni et al, J Mater Sci, 47, 7978 (2012).

There is therefore a need for improved materials and methods for making defect-free solid electrolytes. What is needed are, for example, new separators, e.g., a thin-film lithium-stuffed garnet separator which is defect-free, as well as methods for making and using the same. The instant disclosure provides solutions to some of these problems in the relevant field as well new separators for Li⁺ rechargeable batteries.

### SUMMARY

In one embodiment, set forth herein is a Li⁺ ion-conducting separator, wherein the separator is polycrystalline and has a d₉₀ grain size that is less than 20 μm and wherein the separator transmits greater than 30% of incident light at 500 nm, 600 nm, or 700 nm wavelength. In some examples, this separator is a thin film approximately 10 nm to 500 μm in thickness and has a Li⁺ ion conductivity greater than 1*10⁻³ S/cm. In certain examples, the separator includes an oxide, a sulfide, a borohydride, or a halide which conducts Li⁺ ions.

In a second embodiment, set forth herein are method for making a Li⁺ ion-conducting separator, wherein the separator is polycrystalline and has a d₉₀ grain size that is less than 20 μm and wherein the separator transmits greater than 30% of incident light at 500 nm, 600 nm, or 700 nm wavelength. In some of these methods, the methods include at least one step which includes conventional sintering, hot isostatic pressing, sinter forging, gel casting, hot pressing sintering, spark plasma sintering, or a combination thereof.

In a third embodiment, set forth herein are electrochemical devices (e.g., rechargeable batteries) which include a solid separator described herein.

In a fourth embodiment, set forth herein are methods of using the electrochemical devices described herein.

### BRIEF DESCRIPTIONS OF THE DRAWINGS

FIG. 1. shows an optical image of a translucent LPSI separator, prepared

according to Example 1.

FIG. 2. shows an optical image of a translucent lithium-stuffed garnet separator, prepared according to Example 1.

FIG. 3 shows a schematic of spark plasma sintering (SPS).

FIG. 4 shows an XRD pattern of a translucent lithium-stuffed garnet separator prepared according to Example 2 (top) overlaid with a reference XRD pattern (bottom).

FIG. 5 shows DC cycling of a translucent lithium-stuffed garnet separator, prepared according to Example 2.

FIG. 6 shows an optical image of a translucent lithium-stuffed garnet separator, prepared according to Example 2.

FIG. 7 shows an Arrhenius plot of conductivity [Log(σ)] as a function of 1/T wherein T is Temperature in Kelvin for a translucent lithium-stuffed garnet separator, prepared according to Example 2.

FIG. 8 shows a plot of transmission versus wavelength for a translucent lithium-stuffed garnet separator, prepared according to Example 2.

FIG. 9 shows a plot of fracture strength as determined by a ring-on-ring biaxial flexural strength test versus d₉₀ grain diameter as determined by quantitative SEM analysis of a surface of a tape-cast separator.

FIG. 10A shows a FIB cross-section image of a translucent and high density lithium-stuffed garnet separator, prepared according to Example 2. FIG. 10B shows the output of quantitative porosity determination for the image in FIG. 10A, showing a density of 99.95%.

### DETAILED DESCRIPTION

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the inventions herein are not intended to be limited to the embodiments presented, but are to be accorded their widest scope consistent with the principles and novel features disclosed herein.

All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### I. Definitions

As used herein, the term “about,” when qualifying a number, e.g., 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, the phrase “Li⁺ ion-conducting separator,” refers to an solid electrolyte which conducts Li⁺ ions, is substantially insulating to electrons (e.g., the lithium ion conductivity is at least >10³ and often >10⁶ times greater than the electron conductivity), and which acts as a physical barrier or spacer between the positive and negative electrodes in an electrochemical cell.

As used herein “median diameter (d₅₀)” refers to the median size, in a distribution of sizes, measured by microscopy techniques or other particle size analysis techniques, including, but not limited to, scanning electron microscopy or dynamic light scattering. D₅₀ by number includes the characteristic dimension at which 50% of the particles are smaller than the recited size; D₅₀ by area (volume) refers to the diameter of the particle for which half of the area (volume) is filled by smaller particles. Unless otherwise specified, D₅₀ refers to a D₅₀ by area as calculated by SEM grain size analysis.

As used herein “diameter (d₉₀)” refers to the size, in a distribution of sizes, measured by microscopy techniques or other particle size analysis techniques, including, but not limited to, scanning electron microscopy or dynamic light scattering. D₉₀ by number includes the characteristic dimension at which 90% of the particles have diameters smaller than the recited size. D₉₀ by area (volume) refers to a diameter of the particle for which 90% of the area (volume) is filled by smaller particles. Unless otherwise specified, D₉₀ refers to a D₉₀ by area as calculated by SEM grain size analysis.

As used herein “diameter (d₁₀)” refers to the size, in a distribution of sizes, measured by microscopy techniques or other particle size analysis techniques, including, but not limited to, scanning electron microscopy or dynamic light scattering. D₁₀ by number includes the characteristic dimension at which 10% of the particles are smaller than the recited size.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrases “electrochemical cell” or “battery cell” shall mean a single cell including a positive electrode and a negative electrode, which have ionic communication between the two using an electrolyte. In some embodiments, the same battery cell includes multiple positive electrodes and/or multiple negative electrodes enclosed in one container.

As used herein, the terms “cathode” and “anode” refer to the electrodes of a battery. During a charge cycle in a Li-secondary battery, Li ions leave the cathode and move through an electrolyte, to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode.

As used herein, the term “catholyte,” refers to a Li ion conductor that is intimately mixed with, or that surrounds, or that contacts the positive electrode active materials and provides an ionic pathway for Li⁺ to and from the active materials. Catholytes suitable with the embodiments described herein include, but are not limited to, catholytes having the acronyms name LPS, LXPS, LXPSO, where X is Si, Ge, Sn, As, Al, LATS, or also Li-stuffed garnets, or combinations thereof, and the like. Catholytes may also be liquid, gel, semi-liquid, semi-solid, polymer, and/or solid polymer ion conductors known in the art. Catholytes include those catholytes set forth in US Patent Application Publication No. 2015-0171465, which published on Jun. 18, 2015, entitled SOLID STATE CATHOLYTE OR ELECTROLYTE FOR BATTERY USING Li_{A}MP_{B}S_{C} (M=Si, Ge, AND/OR Sn), filed May 15, 2014, the contents of which are incorporated by reference in their entirety. Catholytes include those catholytes set forth in US Patent Application Publication No. 2015/0099190, published on Apr. 9, 2015, entitled GARNET MATERIALS FOR LI SECONDARY BATTERIES AND METHODS OF MAKING AND USING GARNET MATERIALS, and filed Oct. 7, 2014, the contents of which are incorporated by reference in their entirety. In some examples, the gel electrolyte referred to herein is an 80:20 to 50:50 vol. % PVDF: HFP to EC: EMC. Herein, PVDF is polyvinylidene fluoride; HFP is hexafluorophosphate; EC is ethylene carbonate; and EMC is ethyl methyl carbonate.

As used herein, the term “electrolyte,” refers to an ionically conductive and electrically insulating material. Electrolytes are useful for electrically insulating the positive and negative electrodes of a secondary battery while allowing for the conduction of ions, e.g., Li⁺, through the electrolyte. In some of the electrochemical devices described herein, the electrolyte includes a solid film, pellet, or monolith of a Li⁺ conducting oxide, such as a lithium-stuffed garnet. In some examples, the electrolyte further includes a gel electrolyte which is laminated to or directly contacting the solid film, pellet, or monolith.

As used herein, the phrase “pellet” refers to a body of material produced by a batch process with at least one compaction step. The pellet may be a “green pellet”, i.e., before heating or sintering, or a “sintered pellet”, i.e., after heating or sintering at elevated temperatures to cause densification.

As used herein, the phrase “monolith” refers to a body of material that, on a length scale of ≥0.1 mm, is substantially uniform or homogeneous in structure and composition.

As used herein, the term “rational number” refers to any number which can be expressed as the quotient or fraction (e.g., p/q) of two integers (e.g., p and q), with the denominator (e.g., q) not equal to zero. Example rational numbers include, but are not limited to, 1, 1.1, 1.52, 2, 2.5, 3, 3.12, and 7.

As used herein, the phrase “subscripts and molar coefficients in the empirical formulas are based on the quantities of raw materials initially batched to make the described examples” means the subscripts, (e.g., 7, 3, 2, 12 in Li₇La₃Zr₂O₁₂ and the coefficient 0.35 in 0.35Al₂O₃) refer to the respective elemental ratios in the chemical precursors (e.g., LiOH, La₂O₃, ZrO₂, Al₂O₃) used to prepare a given material, (e.g., Li₇La₃Zr₂O₁₂.0.35Al₂O₃).

As used herein, a “thickness” by which is film is characterized refers to the distance, or median measured distance, between the top and bottom faces of a film. As used herein, the top and bottom faces refer to the sides of the film having the largest surface area.

As used herein, the phrase “lithium stuffed garnet” refers to oxides that are characterized by a crystal structure related to a garnet crystal structure. U.S. Patent Application Publication No. U.S. 2015/0099190, which published Apr. 9, 2015 and was filed Oct. 7, 2014 as 14/509,029, is incorporated by reference herein in its entirety. This application describes Li-stuffed garnet solid-state electrolytes used in solid-state lithium rechargeable batteries. These Li-stuffed garnets generally having a composition according to Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4,0≤C≤2,0≤D≤2; 0≤E<3, 10<F<13, and M′ and M″ are each, independently in each instance selected from Ga, Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me″ is a metal selected from Ga, Nb, Ta, V, W, Mo, or Sb and as otherwise described in U.S. Patent Application Publication No. U.S. 2015/0099190, the entire contents of which are herein incorporated by reference in its entirety for all purposes. As used herein, lithium-stuffed garnets, and garnets, generally, include, but are not limited to, Li_{7.0}La₃ (Zrₜ₁+Nbₜ₂+Taₜ₃)O₁₂+0.35Al₂O₃; wherein (t1+t2+t3=2) so that the La: (Zr/Nb/Ta) ratio is 3:2. Also, garnets used herein include, but are not limited to, LiₓLa₃Zr₂O_{F}+yAl₂O₃, wherein x ranges from 5.5 to 9; and y ranges from 0.05 to 1. In these examples, subscripts x, y, and F are selected so that the garnet is charge neutral. In some examples x is 7 and y is 1.0. In some examples, x is 5 and y is 1.0. In some examples, x is 6 and y is 1.0. In some examples, x is 8 and y is 1.0. In some examples, x is 9 and y is 1.0. In some examples x is 7 and y is 0.35. In some examples, x is 5 and y is 0.35. In some examples, x is 6 and y is 0.35. In some examples, x is 8 and y is 0.35. In some examples, x is 9 and y is 0.35. In some examples x is 7 and y is 0.7. In some examples, x is 5 and y is 0.7. In some examples, x is 6 and y is 0.7. In some examples, x is 8 and y is 0.7. In some examples, x is 9 and y is 0.7. In some examples x is 7 and y is 0.75. In some examples, x is 5 and y is 0.75. In some examples, x is 6 and y is 0.75. In some examples, x is 8 and y is 0.75. In some examples, x is 9 and y is 0.75. In some examples x is 7 and y is 0.8. In some examples, x is 5 and y is 0.8. In some examples, x is 6 and y is 0.8. In some examples, x is 8 and y is 0.8. In some examples, x is 9 and y is 0.8. In some examples x is 7 and y is 0.5. In some examples, x is 5 and y is 0.5. In some examples, x is 6 and y is 0.5. In some examples, x is 8 and y is 0.5. In some examples, x is 9 and y is 0.5. In some examples x is 7 and y is 0.4. In some examples, x is 5 and y is 0.4. In some examples, x is 6 and y is 0.4. In some examples, x is 8 and y is 0.4. In some examples, x is 9 and y is 0.4. In some examples x is 7 and y is 0.3. In some examples, x is 5 and y is 0.3. In some examples, x is 6 and y is 0.3. In some examples, x is 8 and y is 0.3. In some examples, x is 9 and y is 0.3. In some examples x is 7 and y is 0.22. In some examples, x is 5 and y is 0.22. In some examples, x is 6 and y is 0.22. In some examples, x is 8 and y is 0.22. In some examples, x is 9 and y is 0.22. Also, garnets as used herein include, but are not limited to, LiₓLa₃Zr₂O₁₂+yAl₂O₃. In one embodiment, the Li-stuffed garnet herein has a composition of Li₇Li₃Zr₂O₁₂. In another embodiment, the Li-stuffed garnet herein has a composition of Li₇Li₃Zr₂O₁₂. Al₂O₃. In yet another embodiment, the Li-stuffed garnet herein has a composition of Li₇Li₃Zr₂O₁₂.0.22Al₂O₃. In yet another embodiment, the Li-stuffed garnet herein has a composition of Li₇Li₃Zr₂O₁₂.0.35Al₂O₃. In certain other embodiments, the Li-stuffed garnet herein has a composition of Li₇Li₃Zr₂O₁₂.0.5Al₂O₃. In another embodiment, the Li-stuffed garnet herein has a composition of Li₇Li₃Zr₂O₁₂.0.75Al₂O₃.

As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the phrase “phase pure” refers to a material characterized as having a single phase (i.e., type of solid matter) as determined by x-ray powder diffraction (XRD) analysis. For example, phase pure cubic lithium-stuffed garnet is a material having a cubic crystalline structure. The material includes lithium (Li), lanthanum (La), zirconium (Zr), oxygen (O) and optionally dopant atoms (e.g., Al) bonded in a polycrystalline array, wherein each unit cell in the crystallite has cubic symmetry. Phase pure lithium-stuffed garnet includes the solid material, Li₇La₃Zr₂O₁₂, wherein the amounts of Li, La, Zr, and O may vary so long as the material remains polycrystalline, with cubic crystalline symmetry. Li₇La₃Zr₂O₁₂ can form several crystal phases. One phase that Li₇La₃Zr₂O₁₂ forms in addition to a cubic phase is a tetragonal crystalline phase which includes Li, La, Zr, and O atoms bonded in a polycrystalline array, wherein each unit cell within the crystallite has tetragonal symmetry. Phase pure cubic lithium-stuffed garnet is a lithium-stuffed garnet that is at least 99% or more by volume cubic lithium-stuffed garnet. Phase pure cubic lithium-stuffed garnet is phase pure even though the respective amounts of Li, La, Zr, O, and/or Al change so long as the lithium-stuffed garnet remains polycrystalline, with cubic crystalline symmetry. For example, Li₇La₃Zr₂O₁₂ may be doped with Al or Al₂O₃ and remain phase pure so long as the doped composition, e.g., Li₇La₃Zr₂O₁₂Al₂O₃, is polycrystalline, with each unit cell having cubic crystalline symmetry. A lithium-stuffed garnet that includes more than trace amounts (more than 1% by volume) of secondary phases is not phase pure.

Examples of phase pure lithium-stuffed garnets as well as lithium-stuffed garnets having primary and secondary phases are found, for example, in U.S. patent application Ser. No. 15/631,884, filed Jun. 23, 2017, entitled LITHIUM BATTERY ELECTROLYTE WITH PHASE INCLUSIONS, and in International PCT Patent Application No. PCT/US2017/039069, filed Jun. 23, 2017, entitled LITHIUM BATTERY ELECTROLYTE WITH PHASE INCLUSIONS.

As used herein, the phrase “secondary phase” refers to a distinct phase within or adjacent to a primary phase, wherein the primary phase is the phase present is the greatest amount. For example, a small amount of LiAlO₂ phase within a bulk Li₂La₃Zr₂O₁₂Alₓ phase is a secondary phase. The secondary phase may be identified and quantified, for example, by quantitative x-ray powder diffraction analysis. The secondary phase may be identified and quantified, for example, by quantitative electron microscopy, e.g., SEM in back-scattered electron imaging mode, which shows density contrast. As another example, glancing incidence XRD may be used to identify small secondary phases on the surface of a body, such as but not limited to a pellet or thin film. As another example, selected area x-ray diffraction patterns in transmission electron microscopy may identify microscopic secondary phases. Some secondary phases may be amorphous, weakly diffracting, or thin or small enough as to not be easily identifiable via diffraction techniques. When cubic lithium-stuffed garnet is the primary phase (i.e., the phase present in largest amount by volume), the secondary phases include, but are not limited to tetragonal phase garnet; La₂Zr₂O₇; La₂O₃; LaAlO₃; La₂(Li_{0.5}Al_{0.5})O₄; LiLaO₂; LiZr₂O₃; LiₐZr_{b}O_{c}, wherein 1≤a≤8, 1≤b≤2, and 1≤c≤7, and wherein subscripts a, b, and c are selected so that LiₐZr_{b}O_{c} is charge neutral; Li_{g}AlₕOᵢ, wherein 1≤g≤5, 1≤h≤5, and 2≤i≤8, and wherein subscripts g, h, i are selected so that Li_{g}AlₕOᵢ is charge neutral; La_{d}TaₑO_{f}, wherein 1≤d<3, 1≤e≤7, and 4≤f≤19, and wherein subscripts d, e, and f are selected so that La_{d}TaₑO_{f} is charge neutral; LiᵣTaₛOₜ, wherein 1≤r≤2, 1≤s≤3, and 3≤t≤7, and wherein subscripts r, s, and t are selected so that LiᵣTaₛOₜ is charge neutral; LaₙNbₚO_{q}, wherein 1≤n≤3, 1≤p≤7, and 4≤q≤19, and wherein subscripts n, p, and q are selected so that LaₙNbₚO_{q} is charge neutral; LiᵤNbᵥOₓ, wherein 1≤u≤3, 1≤p≤3, and 3≤x≤9, and wherein subscripts u, v, and x are selected so that LiᵤNbᵥOₓ is charge neutral; and any combination thereof.

As used herein, the phrases “garnet precursor chemicals,” “chemical precursor to a garnet-type electrolyte,” “precursors to garnet” and “garnet precursor materials” refers to chemicals, which react to form a lithium-stuffed garnet material described herein. These chemical precursors include, but are not limited to lithium hydroxide (e.g., LiOH), lithium oxide (e.g., Li₂O), zirconium oxide (e.g., ZrO₂), zirconium nitrate, zirconium acetate, lanthanum oxide (e.g., La₂O₃), lanthanum nitrate, lanthanum acetate, aluminum oxide (e.g., Al₂O₃), aluminum (e.g., Al), aluminum nitrate (e.g., AlNO₃), aluminum nitrate nonahydrate, aluminum (oxy) hydroxide (gibbsite and boehmite), gallium oxide, corundum, niobium oxide (e.g., Nb₂O₅), tantalum oxide (e.g., Ta₂O₅).

As used herein the phrase “garnet-type electrolyte,” refers to an electrolyte that includes a lithium stuffed garnet material described herein as the Li⁺ ion conductor. The advantages of Li-stuffed garnet solid-state electrolytes are many, including as a substitution for liquid, flammable electrolytes commonly used in lithium rechargeable batteries.

As used herein, the phrase “doped with alumina” means that Al₂O₃ is used to replace certain components of another material, e.g., a garnet. A lithium stuffed garnet that is doped with Al₂O₃ refers to garnet wherein aluminum (Al) substitutes for an element in the lithium stuffed garnet chemical formula, which may be, for example, Li or Zr.

As used herein, the term “defect” refers to an imperfection or a deviation from a pristine structure that interacts with (absorbs, scatters, reflects, refracts, etc) light. Defects may include, but not limited to, a pore, a grain boundary, a dislocation, a crack, a separation, a chemical inhomogeneity, or a phase segregation of two or more materials in a solid material. A perfect crystal is an example of a material that lacks defects. A nearly 100% dense oxide electrolyte that has a planar surface, with substantially no pitting, inclusions, cracks, pores, or divots on the surface, is an example of an electrolyte that is substantially lacking defects. Defects can include a second phase inclusion (e.g., a LizS phase inside a LPSI electrolyte). Defects can include a pore inclusion. Defects can include a grain boundary wherein two adjacent grains have a region where their separation is greater than 10 nm. Defects can include pores in a porous separator

As used herein, the phrase “defect density,” refers to the volumetric density of defects. For example, if the defect in a primary phase is a second phase inclusion, and the second phase inclusion occupies 10% of the volume of the primary phase in which the secondary phase is, then the defect density is 10% by volume.

As used herein, the phrase “scattering center,” refers to a position in a material which scatters light waves which range from 500 nm to 700 nm in wavelength.

As used herein, the phrase “geometric porosity,” refers to fractional volume attributed to pore space, calculated by measuring the geometric density and dividing by the theoretical crystalline density, and subtracting that quotient from the number, 1.

As used herein, the phrase “lithium interfacial resistance,” refers to the interfacial resistance of a material towards the incorporation and conduction of Li⁺ ions. A lithium interfacial ASR (ASR_{interface}) is calculated from the interfacial resistance (R_{interface}) via ASR_{interface}=R_{interface}*A/2 where A is the area of the electrodes in contact with the separator and the factor of 2 accounts for 2 interfaces, assuming they are symmetric, as demonstrated in Example 5, herein.

As used herein, the term “uniform,” refers to a property characterization which is constant over a given surface area or volume, e.g., over a surface area of at least 100 nm² or over a volume of at least 1000 nm³.

As used herein the term “porous,” refers to a material that includes pores, e.g., nanopores, mesopores, or micropores.

As used herein, the phrase “porosity as determined by SEM,” refers to measurement of density by using an image analysis software. First, a user or software assigns pixels and/or regions of an image as porosity. Second, the area fraction of those regions is summed. Finally, the porosity fraction determined by SEM is equal to the area fraction of the porous region of the image.

As used here, the phrase “inorganic solid state electrolyte,” refers to a material not including a majority phase of carbon which conducts ions (e.g., Li⁺) but does not conduct electrons. Example inorganic solid state electrolytes include oxide electrolytes and sulfide electrolytes, which are further described in the instant disclosure.

In some examples, the electrolytes herein may include, or be layered with, or be laminated to, or contact a sulfide electrolyte. As used here, the phrase “sulfide electrolyte,” includes, but is not limited to, electrolytes referred to herein as LSS, LTS, LXPS, or LXPSO, where X is Si, Ge, Sn, As, Al, or Li—Sn—Si—P—S or Li—As—Sn—S. In these acronyms (LSS, LTS, LXPS, or LXPSO), S refers to the element S, Si, or combinations thereof, and T refers to the element Sn. “Sulfide electrolyte” may also include LiₐP_{b}S_{c}X_{d}, LiₐB_{b}S_{c}X_{d}, LiₐSn_{b}Si_{b′}S_{c}X_{d}, LiₐSn_{b}S_{c}X_{d} or LiₐSi_{b}S_{c}X_{d} where X=F, Cl, Br, I, and 10%≤a≤50%, 10%≤b, b′≤44%, 24%≤c≤70%, 0≤d≤18%. “Sulfide electrolyte” may also include LiₐP_{b}Si_{c}Sn_{d}XₑO_{f} where 10%≤a≤50%, 5%≤b≤30%, 0≤c≤10%, 0≤d≤10%, 0≤e≤30%, 0≤f<10% and X=F, Cl, Br, I, or mixtures thereof. Up to 10 at % oxygen may be present in the sulfide electrolytes, either by design or as a contaminant species.

In some examples, the sulfide electrolyte layer is a material containing Si, Li, O, P, and S and is referred to herein as a SLOPS material. In some examples, the electrolyte layer is a material containing Si, Li, O, P, and S and is referred to herein as a SLOPS/LSS material. As used herein, LSS includes, unless otherwise specified, a 60:40 molar ratio Li₂S:SiS₂.

As used herein, “SLOPS” includes, unless otherwise specified, a 60:40 molar ratio of Li₂S:SiS₂ with 0.1-10 mol. % Li₃PO₄. In some examples, “SLOPS” includes Li₁₀Si₄S₁₃ (50:50 Li₂S:SiS₂) with 0.1-10 mol. % Li₃PO₄. In some examples, “SLOPS” includes Li₂₆Si₇S₂₇ (65:35 Li₂S:SiS₂) with 0.1-10 mol. % Li₃PO₄. In some examples, “SLOPS” includes Li₄SiS₄ (67:33 Li₂S:SiS₂) with 0.1-5 mol. % Li₃PO₄. In some examples, “SLOPS” includes Li₁₄Si₃S₁₃ (70:30 Li₂S:SiS₂) with 0.1-5 mol. % Li₃PO₄. In some examples, “SLOPS” is characterized by the formula (1-x)(60:40 Li₂S:SiS₂)*(x)(Li₃PO₄), wherein x is from 0.01 to 0.99.As used herein, “LBS-POX” refers to an electrolyte composition of Li₂S:B₂S₃:Li₃PO₄:LiX where X is a halogen (X=F, Cl, Br, I). The composition can include Li₃BS₃ or Li₅B₇S₁₃ doped with 0-30% lithium halide such as LiI and/or 0-10% Li₃PO₄.

As used here, “LSS” refers to lithium silicon sulfide which can be described as Li₂S—SiS₂, Li—SiS₂, Li—S—Si, and/or a catholyte consisting essentially of Li, S, and Si. LSS refers to an electrolyte material characterized by the formula LiₓSi_{y}S_{z} where 0.33≤x≤0.5, 0.1≤y≤0.2, 0.4≤z≤0.55, and it may include up to 10 atomic % oxygen. LSS also refers to an electrolyte material comprising Li, Si, and S. In some examples, LSS is a mixture of Li₂S and SiS₂. In some examples, the ratio of Li₂S:SiS₂ is 90:10, 85:15, 80:20, 75:25, 70:30, 2:1, 65:35, 60:40, 55:45, or 50:50 molar ratio. LSS may be doped with compounds such as LiₓPO_{y}, LiₓBO_{y}, Li₄SiO₄, Li₃MO₄, Li₃MO₃, PSₓ, and/or lithium halides such as, but not limited to, LiI, LiCl, LiF, or LiBr, wherein 0<x≤5 and 0<y≤5.

As used here, “LTS” refers to a lithium tin sulfide compound which can be described as Li₂S:SnS₂:As₂S₅, Li₂S—SnS₂, Li₂S—SnS, Li—S—Sn, and/or a catholyte consisting essentially of Li, S, and Sn. The composition may be LiₓSn_{y}S_{z} where 0.25≤x≤0.65, 0.05≤y≤0.2, and 0.25≤z≤0.65. In some examples, LTS is a mixture of Li₂S and SnS₂ in the ratio of 80:20, 75:25, 70:30, 2:1, or 1:1 molar ratio. LTS may include up to 10 atomic % oxygen. LTS may be doped with Bi, Sb, As, P, B, Al, Ge, Ga, and/or In and/or lithium halides such as, but not limited to, LiI, LiCl, LiF, or LiBr, As used herein, “LATS” refers to LTS, as used above, and further comprising Arsenic (As).

As used here, “LXPS” refers to a material characterized by the formula LiₐMP_{b}S_{c}, where M is Si, Ge, Sn, and/or Al, and where 2≤a≤8, 0.5≤b≤2.5, 4≤c≤12. “LSPS” refers to an electrolyte material characterized by the formula LₐSiP_{b}S_{c}, where 2≤a≤8, 0.5≤b≤2.5, 4≤c≤12. LSPS refers to an electrolyte material characterized by the formula LₐSiP_{b}S_{c}, wherein, where 2≤a≤8, 0.5≤b≤4≤c≤12, d<3. In these examples, the subscripts are selected so that the compound is neutrally charged. Exemplary LXPS materials are found, for example, in International Patent Application Publication No. PCT/US2014/038283, filed May 16, 2014 as PCT/US2014/038283, and titled SOLID STATE CATHOLYTE OR ELECTROLYTE FOR BATTERY USING LI_{A}MP_{B}S_{C} (M=Si, Ge, AND/OR Sn), which is incorporated by reference herein in its entirety. When M is Sn and Si—both are present—the LXPS material is referred to as LSTPS. As used herein, “LSTPSO,” refers to LSTPS that is doped with, or has, O present. In some examples, “LSTPSO,” is a LSTPS material with an oxygen content between 0.01 and 10 atomic %. “LSPS,” refers to an electrolyte material having Li, Si, P, and S chemical constituents. As used herein “LSTPS,” refers to an electrolyte material having Li, Si, P, Sn, and S chemical constituents. As used herein, “LSPSO,” refers to LSPS that is doped with, or has, O present. In some examples, “LSPSO,” is a LSPS material with an oxygen content between 0.01 and 10 atomic %. As used herein, “LATP,” refers to an electrolyte material having Li, As, Sn, and P chemical constituents. As used herein “LAGP,” refers to an electrolyte material having Li, As, Ge, and P chemical constituents. As used herein, “LXPSO” refers to a catholyte material characterized by the formula LiₐMP_{b}S_{c}O_{d}, where M is Si, Ge, Sn, and/or Al, and where 2≤a≤8, 0.5≤b≤2.5, 4≤c≤12, d<3. LXPSO refers to LXPS, as defined above, and having oxygen doping at from 0.1 to about 10 atomic %. LPSO refers to LPS, as defined above, and having oxygen doping at from 0.1 to about 10 atomic %.

As used here, “LPS,” refers to an electrolyte having Li, P, and S chemical constituents. As used herein, “LPSO,” refers to LPS that is doped with or has O present. In some examples, “LPSO,” is a LPS material with an oxygen content between 0.01 and 10atomic %. LPS refers to an electrolyte material that can be characterized by the formula LiₓP_{y}S_{z} where 0.33≤x≤0.67, 0.07≤y≤0.2 and 0.4≤z≤0.55. LPS also refers to an electrolyte characterized by a product formed from a mixture of Li₂S:P₂S₅ wherein the molar ratio is 10:1, 9:1, 8:1, 7:1, 6:1 5:1, 4:1, 3:1, 7:3, 2:1, or 1:1. LPS also refers to an electrolyte characterized by a product formed from a mixture of Li₂S:P₂S₅ wherein the reactant or precursor amount of Li₂S is 95 atomic % and P₂S₅ is 5 atomic %. LPS also refers to an electrolyte characterized by a product formed from a mixture of Li₂S: P₂S₅ wherein the reactant or precursor amount of Li₂S is 90 atomic % and P₂S₅ is 10 atomic %. LPS also refers to an electrolyte characterized by a product formed from a mixture of Li₂S:P₂S₅ wherein the reactant or precursor amount of Li₂S is 85 atomic % and P₂S₅ is 15 atomic %. LPS also refers to an electrolyte characterized by a product formed from a mixture of Li₂S:P₂S₅ wherein the reactant or precursor amount of Li₂S is 80 atomic % and P₂S₅ is 20 atomic %. LPS also refers to an electrolyte characterized by a product formed from a mixture of Li₂S:P₂S₅ wherein the reactant or precursor amount of Li₂S is 75 atomic % and P₂S₅ is 25 atomic %. LPS also refers to an electrolyte characterized by a product formed from a mixture of Li₂S:P₂S₅ wherein the reactant or precursor amount of Li₂S is 70 atomic % and P₂S₅ is 30 atomic %. LPS also refers to an electrolyte characterized by a product formed from a mixture of Li₂S:P₂S₅ wherein the reactant or precursor amount of Li₂S is 65 atomic % and P₂S₅ is 35 atomic %. LPS also refers to an electrolyte characterized by a product formed from a mixture of Li₂S:P₂S₅ wherein the reactant or precursor amount of Li₂S is 60 atomic % and P₂S₅ is 40 atomic %. LPS may also be doped with a lithium halide such as LiF, LiCl, LiBr, or LiI at a 0-40% molar content.

As used here, “LBS” refers to an electrolyte material characterized by the formula LiₐB_{b}S_{c} and may include oxygen and/or a lithium halide (LiF, LiCl, LiBr, LiI) at 0-40 mol %.

As used here, “LPSO” refers to an electrolyte material characterized by the formula LiₓP_{y}S_{z}O_{w} where 0.33≤x≤0.67, 0.07≤y≤0.2, 0.4≤z≤0.55, 0≤w≤0.15. Also, LPSO refers to LPS, as defined above, that includes an oxygen content of from 0.01 to 10 atomic %. In some examples, the oxygen content is 1 atomic %. In other examples, the oxygen content is 2 atomic %. In some other examples, the oxygen content is 3 atomic %. In some examples, the oxygen content is 4 atomic %. In other examples, the oxygen content is 5 atomic %. In some other examples, the oxygen content is 6 atomic %. In some examples, the oxygen content is 7 atomic %. In other examples, the oxygen content is 8 atomic %. In some other examples, the oxygen content is 9 atomic %. In some examples, the oxygen content is 10 atomic %.

As used herein, the term “LBHI” refers to a lithium conducting electrolyte comprising Li, B, H, and I. LBHI includes a compound having the formula aLiBH₄+bLiX where X=Cl, Br, and/or I and where a:b=7:1, 6:1, 5:1, 4:1, 3:1, 2:1, or within the range a/b=2−4. LBHI may further include nitrogen in the form of compound having the formula aLiBH₄+bLiX+cLiNH₂ where (a+c)/b=2−4 and c/a=0−10.

As used herein, the term “LPSI” refers to a lithium conducting electrolyte comprising Li, P, S, and I. LPSI includes a compound having the formula aLi₂S+bP₂S_{y}+cLiX where X=Cl, Br, and/or I and where y=3−5 and where a/b=2.5−4.5 and where (a+b)/c=0.5−15.

As used herein, the term “LIRAP” refers to a lithium rich antiperovskite and is used synonymously with “LOC” or “Li₃OCl”. The composition of LIRAP is aLi₂O+bLiX+cLiOH+dAl₂O₃ where X=Cl, Br, I, or mixtures thereof, a/b=0.7−9, c/a−0.01−10, d/a=0.001−0.1.

As used herein, the term “grains” refers to domains of material within the bulk of a material that have a physical boundary which distinguishes the grain from the rest of the material. For example, in some materials both crystalline and amorphous components of a material, often having the same chemical composition, are distinguished from each other by the boundary between the crystalline component and the amorphous component. The approximate diameter within the boundaries of a crystalline component, or of an amorphous component, is referred herein as the grain size. Grains may be observed in SEM if appropriate techniques are applied to bring the grains into higher relief; these techniques may include chemical etching or exposure to high energy electron beams.

As used herein, the phrase “grain size” refers the characteristic dimension, or maximum dimension (e.g., diameter of a spherically-shaped grain), defining a region that has a homogeneous composition, crystalline structure, and crystal orientation. Grains can be observed by high resolution TEM or electron back-scatter diffraction (EBSD).

As used herein, the phrase “green film” refers to an unsintered film including at least one member selected from garnet materials, precursors to garnet materials, binder, solvent, carbon, dispersant, or combinations thereof.

As used herein the term “making,” refers to the process or method of forming or causing to form the object that is made. For example, making an energy storage electrode includes the process, process steps, or method of causing the electrode of an energy storage device to be formed. The end result of the steps constituting the making of the energy storage electrode is the production of a material that is functional as an electrode.

As used herein, the phrase “providing” refers to the provision of, generation or, presentation of, or delivery of that which is provided.

As used herein, the term, “Ra,” is a measure of surface roughness wherein Ra is an arithmetic average of absolute values of sampled surface roughness amplitudes where the sampling is performed over an area of 1 mm² to 10 cm². Surface roughness measurements can be accomplished using, for example, a Keyence VK-X100 instrument that measures surface roughness using a laser. As used herein, the term, “Rt,” is a measure of surface roughness wherein Rt is the maximum peak height of sampled surface roughness amplitudes. Disclosed herein are methods of modifying the surface roughness of an oxide electrolyte, which methods include polishing, ablating, exposing to laser, exposing to plasma, exposing to ozone, exposing to a reducing atmosphere at elevate temperatures such as but not limited to 400° C., 500° C., 600° C., 700° C., 800° C., 900° C., 1000° C., 1100° C., 1200° C., 1300° C., or higher, or annealing the surface in order to achieve the desired surface roughness.

As used herein, surface roughness refers to a measurement of either an arithmetic average of absolute values of sampled surface roughness amplitudes or a measurement of the maximum peak height of sampled surface roughness amplitudes. As used herein, the term, “Ra,” is a measure of surface roughness wherein Ra is an arithmetic average of absolute values of sampled surface roughness amplitudes. Surface roughness measurements can be accomplished using, for example, a Keyence VK-X100 instrument that measures surface roughness using a laser. As used herein, the term, “Rt,” is a measure of surface roughness wherein Rt is the maximum peak height of sampled surface roughness amplitudes.

As used herein, the phrase “density as determined by geometric measurements,” refers to measurements of density obtained by physical mass and volume measurements. Density is determined by the ratio of measured mass to the measured volume. Customary techniques including the Archimedes method may be employed for such determinations.

As used herein, the phrase “density as determined by scanning electron microscopy (SEM),” refers to the analysis of scanning electron microscopy (SEM) images. This analysis includes measuring the relative amounts of the electrolyte separator which are porous or vacant with respect to the electrolyte separator which is fully dense. The SEM images useful for this analysis include those obtained by SEM cross-sectional analysis using focused ion beam (FIB) milling.

As used herein, the phrase “density as measured by the Archimedes method,” refers to a density inclusive of closed porosity but exclusive of open porosity. The dimensions of a dry part are measured and the volume is calculated and recorded as V_{d}; the mass of the dry part is measured and recorded as ma. Vacuum infiltration of the part with a solvent such as toluene or IPA is then conducted by, for example, pulling a vacuum om the parts for at least one hour to a pressure less than −20 inHg and then submerge the parts in solvent, infiltrate for at least 30 minutes. Next, the vacuum is releases, keeping parts submerged in solvent. Then, the surface liquid is wiped off of the part, and record the mass m_{w} of the part when wet. Finally, recording the mass mₛ of the part when submerged in the cup is performed. The Archimedes bulk density is calculated as m_{d}/(m_{w}−mₛ)ρₛ, where ρₛ is the solvent density, and the open porosity is (m_{w}−m_{d})/(m_{w}−mₛ).

As used herein the phrase “free-standing thin film,” refers to a film that is not adhered or supported by an underlying substrate. In some examples, free-standing thin film is a film that is self-supporting, which can be mechanically manipulated or moved without need of a substrate adhered or fixed thereto. A free-standing thin film can be laminated or bonded to a current collector or electrode, but such a free-standing thin film is only free-standing when not supported by an underlying substrate. A free-standing thin film is at least 0.5cm² in lateral extent. Lateral extent is determined by multiplying the length of the film by the width of the film. For example, a film that has a length of 0.71 cm and a width of 0.71 cm would have a lateral extent of 0.5 cm². For example, a film that has a length of 0.1 cm and a width of 0.5 cm would have a lateral extent of 0.5 cm². These are non-limiting lateral extent examples.

As used here, the phrase “inorganic solid state electrolyte,” refers to a material not including carbon which conducts ions (e.g., Li⁺) but does not conduct electrons. Example inorganic solid state electrolytes include oxide electrolytes and sulfide electrolytes, which are further described in the instant disclosure.

As used here, the term “transparent” refers to a material that has a

transmission coefficient of greater than 0.9 when measured with incident light in transmission mode at a wavelength between 400-700 nm for a sample that is less than 100 μm thick. As used here, the term “translucent” refers to a material that has a transmission coefficient of between 0.1-0.9 when measured with incident light at a wavelength between 400-700 nm.

As used herein, the phrase “transmission coefficient,” refers to the ratio of the amount of incident light which transmits through a material with respect to the total amount of incident light. A transmission coefficient of 0.5 means that half of the incident light which impinges upon a material transmits through that material.

### II. Separators

In some examples, set forth herein is a Li⁺ ion-conducting separator, wherein the separator is polycrystalline and transmits greater than 30% of incident light at 500 nm, 600 nm, or 700 nm incident wavelength. In certain examples, the separator transmits greater than 35% of incident light at 500 nm, 600 nm, or 700 nm incident light wavelength. In certain other examples, the separator transmits greater than 40% of incident light at 500 nm, 600 nm, or 700 nm incident light wavelength. In some examples, the separator transmits greater than 45% of incident light at 500 nm, 600 nm, or 700 nm incident light wavelength. In some other examples, the separator transmits greater than 50% of incident light at 500 nm, 600 nm, or 700 nm incident light wavelength. In certain examples, the separator transmits greater than 55% of incident light at 500 nm, 600 nm, or 700 nm incident light wavelength. In certain other examples, the separator transmits greater than 60% of incident light at 500 nm, 600 nm, or 700 nm incident light wavelength. In some examples, the separator transmits greater than 65% of incident light at 500 nm, 600 nm, or 700 nm incident light wavelength. In some other examples, the separator transmits greater than 70% of incident light at 500 nm, 600 nm, or 700 nm incident light wavelength. In certain examples, the separator transmits greater than 75% of incident light at 500 nm, 600 nm, or 700 nm incident light wavelength. In certain other examples, the separator transmits greater than 80% of incident light at 500 nm, 600 nm, or 700 nm incident light wavelength. In some examples, the separator transmits greater than 85% of incident light at 500 nm, 600 nm, or 700 nm incident light wavelength. In some other examples, the separator transmits greater than 90% of incident light at 500 nm, 600 nm, or 700 nm incident light wavelength. In certain examples, the separator transmits greater than 95% of incident light at 500 nm, 600 nm, or 700 nm incident light wavelength.

In certain other examples, the separator transmits greater than 96% of incident light at 500 nm, 600 nm, or 700 nm incident light wavelength. In some other examples, the separator transmits greater than 97% of incident light at 500 nm, 600 nm, or 700 nm incident light wavelength. In certain examples, the separator transmits greater than 98% of incident light at 500 nm, 600 nm, or 700 nm incident light wavelength. In some examples, the separator transmits greater than 99% of incident light at 500 nm, 600 nm, or 700 nm incident light wavelength. In some other examples, the separator transmits greater than 99.5% of incident light at 500 nm, 600 nm, or 700 nm incident light wavelength. In certain examples, the separator transmits greater than 99.9% of incident light at 500 nm, 600 nm, or 700 nm incident light wavelength.

In some examples, set forth herein is a Li⁺ ion-conducting separator, wherein the separator is polycrystalline, and has a d₉₀ grain size that is less than 20 μm, and transmits greater than 30% of incident light at 500 nm, 600 nm, or 700 nm incident light wavelength. In some examples, the d₉₀ grain size is less than 19 μm. In some examples, the d₉₀ grain size is less than 18 μm. In some examples, the d₉₀ grain size is less than 17 μm. In some examples, the d₉₀ grain size is less than 16μm. In some examples, the d₉₀ grain size is less than 15 μm. In some examples, the d₉₀ grain size is less than 14 μm. In some examples, the d₉₀ grain size is less than 13 μm. In some examples, the d₉₀ grain size is less than 12 μm. In some examples, the d₉₀ grain size is less than 11 μm. In some examples, the d₉₀ grain size is less than 10 μm. In some examples, the d₉₀ grain size is less than 9 μm. In some examples, the d₉₀ grain size is less than 8 μm. In some examples, the d₉₀ grain size is less than 7 μm. In some examples, the d₉₀ grain size is less than 6 μm. In some examples, the d₉₀ grain size is less than 5 μm. In some examples, the d₉₀ grain size is less than 4 μm. In some examples, the d₉₀ grain size is less than 3 μm. In some examples, the d₉₀ grain size is less than 2 μm. In some examples, the d₉₀ grain size is less than 1 μm. In some examples, the d₉₀ grain size is less than 900 nm. In some examples, the d₉₀ grain size is less than 800 nm. In some examples, the d₉₀ grain size is less than 700 nm. In some examples, the d₉₀ grain size is less than 600 nm. In some examples, the d₉₀ grain size is less than 500 nm. In some examples, the d₉₀ grain size is less than 400 nm. In some examples, the d₉₀ grain size is less than 300 nm. In some examples, the d₉₀ grain size is less than 200 nm. In some examples, the d₉₀ grain size is less than 100 nm. In some examples, the d₉₀ grain size is less than 50 nm.

In some examples, the d₉₀ grain size is less than 5 μm. In some examples, the d₉₀ grain size is less than 3 μm. the d₉₀ grain size is less than 2 μm. In some of these examples, the grain size is related to the strength of the lithium-stuffed garnet film. In some of these examples, the grain size is related to the strength of the lithium-stuffed garnet pellet. In some of these examples, the grain size is related to the strength of the lithium-stuffed garnet monolith.

In some examples, set forth herein is a Li⁺ ion-conducting separator, wherein the separator is polycrystalline, with a d₉₀ grain size is less than 20 μm, and transmits greater than 30% of incident light at 500 nm incident light wavelength. In some examples, the d₉₀ grain size is less than 19 μm. In some examples, the d₉₀ grain size is less than 18 μm. In some examples, the d₉₀ grain size is less than 17 μm. In some examples, the d₉₀ grain size is less than 16 μm. In some examples, the d₉₀ grain size is less than 15 μm. In some examples, the d₉₀ grain size is less than 14 μm. In some examples, the d₉₀ grain size is less than 13 μm. In some examples, the d₉₀ grain size is less than 12 μm. In some examples, the d₉₀ grain size is less than 11 μm. In some examples, the d₉₀ grain size is less than 10 μm. In some examples, the d₉₀ grain size is less than 9 μm. In some examples, the do grain size is less than 8 μm. In some examples, the d₉₀ grain size is less than 7 μm. In some examples, the do grain size is less than 6 μm. In some examples, the d₉₀ grain size is less than 5 μm. In some examples, the d₉₀ grain size is less than 4 μm. In some examples, the d₉₀ grain size is less than 3 μm. In some examples, the d₉₀ grain size is less than 2 μm. In some examples, the do grain size is less than 1 μm. In some examples, the d₉₀ grain size is less than 90 nm. In some examples, the d₉₀ grain size is less than 900 nm. In some examples, the d₉₀ grain size is less than 800 nm. In some examples, the d₉₀ grain size is less than 700 nm. In some examples, the d₉₀ grain size is less than 600 nm. In some examples, the d₉₀ grain size is less than 500 nm. In some examples, the d₉₀ grain size is less than 400 nm. In some examples, the d₉₀ grain size is less than 300 nm. In some examples, the d₉₀ grain size is less than 200 nm. In some examples, the d₉₀ grain size is less than 100 nm. In some examples, the d₉₀ grain size is less than 50 nm.

In some examples, set forth herein is a Li⁺ ion-conducting separator, wherein the separator is polycrystalline, with a d₉₀ grain size is less than 20 μm, and transmits greater than 30% of incident light at 500 nm and 600 nm incident light wavelength. In some examples, the d₉₀ grain size is less than 19 μm. In some examples, the d₉₀ grain size is less than 18 μm. In some examples, the d₉₀ grain size is less than 17 μm. In some examples, the d₉₀ grain size is less than 16 μm. In some examples, the d₉₀ grain size is less than 15 μm. In some examples, the d₉₀ grain size is less than 14 μm. In some examples, the d₉₀ grain size is less than 13 μm. In some examples, the d₉₀ grain size is less than 12 μm. In some examples, the d₉₀ grain size is less than 11 μm. In some examples, the d₉₀ grain size is less than 10 μm.

In some examples, the d₉₀ grain size is less than 9 μm. In some examples, the d₉₀ grain size is less than 8 μm. In some examples, the d₉₀ grain size is less than 7 μm. In some examples, the d₉₀ grain size is less than 6 μm. In some examples, the d₉₀ grain size is less than 5 μm. In some examples, the d₉₀ grain size is less than 4 μm. In some examples, the d₉₀ grain size is less than 3 μm. In some examples, the d₉₀ grain size is less than 2 μm. In some examples, the d₉₀ grain size is less than 1 μm. In some examples, the do grain size is less than 900 nm. . . . In some examples, the d₉₀ grain size is less than 800 nm. In some examples, the d₉₀ grain size is less than 700 nm. In some examples, the d₉₀ grain size is less than 600 nm. In some examples, the d₉₀ grain size is less than 500 nm. In some examples, the d₉₀ grain size is less than 400 nm. In some examples, the d₉₀ grain size is less than 300 nm. In some examples, the d₉₀ grain size is less than 200 nm. In some examples, the d₉₀ grain size is less than 100 nm. In some examples, the d₉₀ grain size is less than 50 nm.

In some examples, set forth herein is a Li⁺ ion-conducting separator, wherein the separator is polycrystalline, with a d₉₀ grain size is less than 20 μm, and transmits greater than 30% of incident light at 600 nm incident light wavelength. In some examples, the d₉₀ grain size is less than 19 μm. In some examples, the d₉₀ grain size is less than 18 μm. In some examples, the d₉₀ grain size is less than 17 μm. In some examples, the d₉₀ grain size is less than 16 μm. In some examples, the d₉₀ grain size is less than 15 μm. In some examples, the do grain size is less than 14 μm. In some examples, the d₉₀ grain size is less than 13 μm. In some examples, the d₉₀ grain size is less than 12 μm. In some examples, the d₉₀ grain size is less than 11 μm. In some examples, the d₉₀ grain size is less than 10 μm. In some examples, the d₉₀ grain size is less than 9 μm. In some examples, the d₉₀ grain size is less than 8 μm. In some examples, the d₉₀ grain size is less than 7 μm. In some examples, the d₉₀ grain size is less than 6 μm. In some examples, the d₉₀ grain size is less than 5 μm. In some examples, the d₉₀ grain size is less than 4 μm. In some examples, the d₉₀ grain size is less than 3 μm. In some examples, the d₉₀ grain size is less than 2 μm. In some examples, the d₉₀ grain size is less than 1 μm. In some examples, the d₉₀ grain size is less than 900 nm. In some examples, the d₉₀ grain size is less than 800 nm. In some examples, the d₉₀ grain size is less than 700nm. In some examples, the d₉₀ grain size is less than 600 nm. In some examples, the d₉₀ grain size is less than 500 nm. In some examples, the d₉₀ grain size is less than 400 nm. In some examples, the d₉₀ grain size is less than 300 nm. In some examples, the d₉₀ grain size is less than 200 nm. In some examples, the d₉₀ grain size is less than 100 nm. In some examples, the d₉₀ grain size is less than 50 nm.

In some examples, set forth herein is a Li⁺ ion-conducting separator, wherein the separator is polycrystalline, with a d₉₀ grain size is less than 20 μm, and transmits greater than 30% of incident light at 700 nm incident light wavelength.

In some examples, set forth herein is a Li⁺ ion-conducting separator, wherein the separator has a transmission coefficient greater than 0.5 to an incident wavelength in the range 300-700 nm.

In some examples, set forth herein is a Li⁺ ion-conducting separator, wherein the separator has a transmission coefficient greater than 0.6 to an incident wavelength in the range 300-700 nm.

In some examples, set forth herein is a Li⁺ ion-conducting separator, wherein the separator has a transmission coefficient greater than 0.7 to an incident wavelength in the range 300-700 nm.

In some examples, set forth herein is a Li⁺ ion-conducting separator, wherein the separator has a transmission coefficient greater than 0.8 to an incident wavelength in the range 300-700 nm.

In some examples, set forth herein is a Li⁺ ion-conducting separator, wherein the separator has a transmission coefficient greater than 0.9 to an incident wavelength in the range 300-700 nm.

In some examples, set forth herein is a Li⁺ ion-conducting separator, wherein the separator has a transmission coefficient greater than 0.95 to an incident wavelength in the range 300-700 nm.

In some examples, set forth herein is a Li⁺ ion-conducting separator, wherein the separator has a transmission percentage greater than 50% of incident light at 500 nm incident light wavelength. In some examples, the transmission percentage is greater than 51%. In some examples, the transmission percentage is greater than 52%. In some examples, the transmission percentage is greater than 53%. In some examples, the transmission percentage is greater than 54%. In some examples, the transmission percentage is greater than 55%. In some examples, the transmission percentage is greater than 56%. In some examples, the transmission percentage is greater than 57%. In some examples, the transmission percentage is greater than 58%. In some examples, the transmission percentage is greater than 59%.

In some examples, set forth herein is a Li⁺ ion-conducting separator, wherein the separator has a transmission percentage greater than 60% at 500 nm incident light wavelength. In some examples, the transmission percentage is greater than 61%. In some examples, the transmission percentage is greater than 62%. In some examples, the transmission percentage is greater than 63%. In some examples, the transmission percentage is greater than 64%. In some examples, the transmission percentage is greater than 65%. In some examples, the transmission percentage is greater than 66%. In some examples, the transmission percentage is greater than 67%. In some examples, the transmission percentage is greater than 68%. In some examples, the transmission percentage is greater than 69%.

In some examples, set forth herein is a Li⁺ ion-conducting separator, wherein the separator has a transmission percentage greater than 70% at 500 nm incident light wavelength. In some examples, the transmission percentage is greater than 71%. In some examples, the transmission percentage is greater than 72%. In some examples, the transmission percentage is greater than 73%. In some examples, the transmission percentage is greater than 74%. In some examples, the transmission percentage is greater than 75%. In some examples, the transmission percentage is greater than 76%. In some examples, the transmission percentage is greater than 77%. In some examples, the transmission percentage is greater than 78%. In some examples, the transmission percentage is greater than 79%.

In some examples, set forth herein is a Li⁺ ion-conducting separator, wherein the separator has a transmission percentage greater than 80% at 500 nm incident light wavelength. In some examples, the transmission percentage is greater than 81%. In some examples, the transmission percentage is greater than 82%. In some examples, the transmission percentage is greater than 83%. In some examples, the transmission percentage is greater than 84%. In some examples, the transmission percentage is greater than 85%. In some examples, the transmission percentage is greater than 86%. In some examples, the transmission percentage is greater than 87%. In some examples, the transmission percentage is greater than 88%. In some examples, the transmission percentage is greater than 89%.

In some examples, set forth herein is a Li⁺ ion-conducting separator, wherein the separator has a transmission percentage greater than 90% at 500 nm incident light wavelength. In some examples, the transmission percentage is greater than 91%. In some examples, the transmission percentage is greater than 92%. In some examples, the transmission percentage is greater than 93%. In some examples, the transmission percentage is greater than 94%. In some examples, the transmission percentage is greater than 95%. In some examples, the transmission percentage is greater than 96%. In some examples, the transmission percentage is greater than 97%. In some examples, the transmission percentage is greater than 98%. In some examples, the transmission percentage is greater than 99%.

In some examples, set forth herein is a Li⁺ ion-conducting separator, wherein the separator has a transmission percentage greater than 99% at 500 nm incident light wavelength.

In some examples, set forth herein is a Li⁺ ion-conducting separator, wherein the separator transmits greater than 30% of 400 nm to 700 nm light. In some examples, the transmission percentage is greater than 91%. In some examples, the transmission percentage is greater than 92%. In some examples, the transmission percentage is greater than 93%. In some examples, the transmission percentage is greater than 94%. In some examples, the transmission percentage is greater than 95%. In some examples, the transmission percentage is greater than 96%. In some examples, the transmission percentage is greater than 97%. In some examples, the transmission percentage is greater than 98%. In some examples, the transmission percentage is greater than 99%.

In some examples, set forth herein is a Li⁺ ion-conducting separator, wherein the separator transmits greater than 40% of incident light at 400 nm to 700 nm incident light wavelength.

In some examples, set forth herein is a Li⁺ ion-conducting separator, wherein the separator transmits greater than 50% of incident light at 400 nm to 700 nm incident light wavelength.

In some examples, set forth herein is a Li⁺ ion-conducting separator, wherein the separator transmits greater than 60% of incident light at 400 nm to 700 nm incident light wavelength.

In some examples, set forth herein is a Li⁺ ion-conducting separator, wherein the separator transmits greater than 70% of incident light at 400 nm to 700 nm incident light wavelength.

In some examples, set forth herein is a Li⁺ ion-conducting separator, wherein the separator transmits greater than 80% of incident light at 400 nm to 700 nm incident light wavelength.

In some examples, set forth herein is a Li⁺ ion-conducting separator, wherein the separator transmits greater than 90% of incident light at 400 nm to 700 nm incident light wavelength.

In some examples, set forth herein is a Li⁺ ion-conducting separator, wherein the separator transmits greater than 99% of incident light at 400 nm to 700 nm incident light wavelength.

In some examples, set forth herein is a Li⁺ ion-conducting separator, wherein the separator is 90% transparent to 400 nm to 700 nm light. In some examples, set forth herein is a Li⁺ ion-conducting separator, wherein the separator is about 70% transparent to 500 nm light when the thickness is less than 100 μm. In some examples, set forth herein is a Li⁺ ion-conducting separator, wherein the separator is about 80% transparent to 500 nm light when the thickness is less than 100 μm. In some examples, set forth herein is a Li⁺ ion-conducting separator, wherein the separator is about 90% transparent to 500 nm light when the thickness is less than 100 μm. In some examples, set forth herein is a Li⁺ ion-conducting separator, wherein the separator is about 95% transparent to 500 nm light when the thickness is less than 100 μm. In some examples, set forth herein is a Li⁺ ion-conducting separator, wherein the separator is about 98% transparent to 500 nm light when the thickness is less than 100 μm. In some examples, set forth herein is a Li⁺ ion-conducting separator, wherein the separator is about 99% transparent to 500 nm light when the thickness is less than 100 μm. In some examples, set forth herein is a Li⁺ ion-conducting separator, wherein the separator is about 70% transparent to 500 nm light when the thickness is less than 50 μm. In some examples, set forth herein is a Li⁺ ion-conducting separator, wherein the separator is about 80% transparent to 500 nm light when the thickness is less than 50 μm. In some examples, set forth herein is a Li⁺ ion-conducting separator, wherein the separator is about 90% transparent to 500 nm light when the thickness is less than 50 μm. In some examples, set forth herein is a Li⁺ ion-conducting separator, wherein the separator is about 95% transparent to 500 nm light when the thickness is less than 50 μm. In some examples, set forth herein is a Li⁺ ion-conducting separator, wherein the separator is about 98% transparent to 500 nm light when the thickness is less than 50 μm. In some examples, set forth herein is a Li⁺ ion-conducting separator, wherein the separator is about 99% transparent to 500 nm light when the thickness is less than 50 μm. In some examples, set forth herein is a Li⁺ ion-conducting separator, wherein the separator is about 70% transparent to 500 nm light when the thickness is less than 30 μm. In some examples, set forth herein is a Li⁺ ion-conducting separator, wherein the separator is about 80% transparent to 500 nm light when the thickness is less than 30 μm. In some examples, set forth herein is a Li⁺ ion-conducting separator, wherein the separator is about 90% transparent to 500 nm light when the thickness is less than 30 μm. In some examples, set forth herein is a Li⁺ ion-conducting separator, wherein the separator is about 95% transparent to 500 nm light when the thickness is less than 30 μm. In some examples, set forth herein is a Li⁺ ion-conducting separator, wherein the separator is about 98% transparent to 500 nm light when the thickness is less than 30 μm. In some examples, set forth herein is a Li⁺ ion-conducting separator, wherein the separator is about 99% transparent to 500 nm light when the thickness is less than 30

In some examples, set forth herein is a Li⁺ ion-conducting separator, wherein the separator has a 10% total reflectance for 400 nm to 700 nm light.

In some examples, set forth herein is a Li⁺ ion-conducting separator, wherein less than 10% of the total reflectance is diffuse reflectance and the remainder of the total reflectance is specular reflectance. In certain examples, the separator with this property has a surface roughness (Ra) less than 5 μm.

In some examples, the separator has a surface roughness from 0.05 μm Rₐ to 4 μm Rₐ, wherein Rₐ is an arithmetic average of absolute values of sampled surface roughness amplitudes. In some examples, the surface roughness from 0.05 μm Rₐ to 4 μm Rₐ. In some examples, the surface has a surface roughness from 0.5 μm Rₜ to 30 μm Rₜ, wherein Rₜ is the maximum peak height of sampled surface roughness amplitudes. In some examples, the surface roughness is from 1.6 μm Rₐ to 2.2 μm Rₐ. In other examples, the surface roughness is from 3.2 μm Rₐ to 3.7 μm Rₐ. In still other examples, the surface roughness is from 1 μm Rₜ to 28 μm Rₜ. In some other examples, the surface roughness is from 10 μm Rₜ to 30 μm Rₜ. In certain examples, the surface roughness is from 15 μm Rₜ to 30 μm Rₜ. In some examples, the crystallite size in the grains is about 200 nm to 1 μm. In some examples, the crystallite size in the grains is about 100 nm to 5 μm. In some examples, the surface roughness is 0.05 μm, 0.1 μm Ra, 0.2 μm Ra, 0.3 μm Ra, 0.4 μm Ra, 0.5 μm Ra, 0.6 μm Ra, 0.7 μm Ra, 0.8 μm Ra, 0.9 μm Ra, 1 μm Ra, 1.5 μm, 2 μm Ra, 2.5 μm Ra, 3 μm Ra, 3.5 μm, or 4 μm Ra.

In some examples, set forth herein is a Li⁺ ion-conducting separator, wherein the separator is an oxide, a sulfide, a sulfide-halide, or a borohydride.

In some examples, set forth herein is a Li⁺ ion-conducting separator, wherein the separator is an oxide selected from a lithium-stuffed garnet characterized by the formula LiₓLa_{y}Zr₂OᵣqAl₂O₃, wherein 4<x<8, 1<y<4, 1<z<3, 6<t<14, 0≤q≤1. In certain examples, q is 0.1, 0.2, 0.3, 0.4, 0.5, 0.6, 0.7, 0.8, 0.9, or 1.

In some examples, set forth herein is a Li⁺ ion-conducting separator, wherein the lithium-stuffed garnet is doped with Al, Nb, Ga, and/or Ta.

In some examples, set forth herein is a Li⁺ ion-conducting separator, wherein the lithium-stuffed garnet is doped with Nb, Ga, and/or Ta, and wherein the separator is not doped with Al.

In some examples, set forth herein is a Li⁺ ion-conducting separator, wherein the lithium-stuffed garnet is LiₐLa_{b}Zr_{c}Al_{d}Me′ₑO_{f}, wherein 5<a<8.5; 2<b<4; 0<c≤2.5; 0≤d<2; 0≤e<2, and 10<f<13 and Me″ is a metal selected from Nb, Ga, Ta, or combinations thereof.

In some examples, set forth herein is a Li⁺ ion-conducting separator, wherein the lithium-stuffed garnet is characterized by the formula LiₓLa_{y}Zr_{z}Oₜ.0.22(Al₂O₃) or LiₓLa_{y}Zr₂Oₜ.(Al₂O₃), wherein 5<x<8.5.

In some examples, set forth herein is a Li⁺ ion-conducting separator, wherein the separator is a sulfide or sulfide-halide selected from LPSI, LSS, SLOPS, LSTPS, SLOBS, or LATS, wherein LPSI, LSS, SLOPS, LSTPS, SLOBS, or LATS are as defined in the definition section. In some examples, set forth herein is a Li⁺ ion-conducting separator, wherein the separator is a LIRAP or LBHI as defined in the definition section.

In some examples, set forth herein is a Li⁺ ion-conducting separator, wherein the separator is a solid thin film, monolith, or a composite with a polymer. In some examples, the separator is a thin film. In some examples, the separator is a monolith. In some examples, the separator is a composite with a polymer.

In some examples, set forth herein is a Li⁺ ion-conducting separator, wherein the separator includes a lithium-stuffed garnet oxide characterized by the formula LiᵤLaᵥZrₓO_{y}.zAl₂O₃, wherein
u is a rational number from 4 to 10;
v is a rational number from 2 to 4;
x is a rational number from 1 to 3;
y is a rational number from 10 to 14; and
z is a rational number from 0 to 1;
In some examples, u, v, x, y, and z are selected so that the lithium-stuffed garnet oxide is charge neutral.

In some examples, set forth herein is a Li⁺ ion-conducting separator, wherein the separator is a lithium-stuffed garnet oxide characterized by the formula LiᵤLaᵥZrₓO_{y}.zAl₂O₃, wherein
u is a rational number from 4 to 10;
v is a rational number from 2 to 4;
x is a rational number from 1 to 3;
y is a rational number from 10 to 14; and
z is a rational number from 0 to 1;
In some examples, u, v, x, y, and z are selected so that the lithium-stuffed garnet oxide is charge neutral.

In some examples, set forth herein is a Li⁺ ion-conducting separator, wherein the separator includes a lithium-stuffed garnet oxide characterized by the formula LiᵤLa₃Zr₂O₁₂.zAl₂O₃, wherein 4≤u≤10 and 0<z≤1.

In some examples, set forth herein is a Li⁺ ion-conducting separator, wherein the separator is a lithium-stuffed garnet oxide characterized by the formula LiᵤLa₃Zr₂O₁₂.zAl₂O₃, wherein 4≤u≤10 and 0<z≤1.

In some examples, set forth herein is a Li⁺ ion-conducting separator, wherein the separator includes a lithium-stuffed garnet oxide characterized by the formula Li_{6.15-7.1}La₃Zr₂O₁₂.0.5Al₂O₃ or Li_{6.4-7.7}La₃Zr₂O₁₂.0.11Al₂O₃.

In some examples, set forth herein is a Li⁺ ion-conducting separator, wherein the separator is a lithium-stuffed garnet oxide characterized by the formula Li_{6.75-7.1}La₃Zr₂O₁₂.0.5Al₂O₃.

In some examples, set forth herein is a Li⁺ ion-conducting separator, wherein the separator includes:
a lithium sulfide characterized by one of the following Formula

LiₐSi_{b}Sn_{c}P_{d}SₑO_{f}, wherein 2≤a≤8, b+c=1, 0.5≤d≤2.5, 4≤e≤12, and 0<f≤10;

Li_{g}AsₕSnⱼSₖOₗ, wherein 2≤g≤6, 0≤h≤1, 0≤j≤1, 2≤k≤6, and 0≤1≤10;

LiₘPₙSₚX_{q}, wherein X=Cl, Br, and/or I, 2≤m≤6, 0≤n≤1, 0≤p≤1, 2≤q≤6; or

a mixture of (Li₂S): (P₂S₅) having a molar ratio from about 10:1 to about 6:4and LiI, wherein the ratio of [(Li₂S):(P₂S₅)]:LiI is from 95:5 to 50:50;

a mixture of LiI and Al₂O₃;

Li₃N;

LIRAP;

LPS+X, wherein X is selected from Cl, I, or Br;

vLi₂S+wP₂S₅+yLiX;

vLi₂S+wSiS₂+LiX;

vLi₂S+wSnS₂+zP₂S₅+yLiX;

vLi₂S+wSiS₂+zP₂S₅+yLiX;

vLi₂S+wB₂S₃+yLiX; a mixture of LiBH₄ and LiX wherein X is selected from Cl, I, or Br; or vLiBH₄+wLiX+yLiNH₂, wherein X is selected from Cl, I, or Br; and wherein coefficients v, w, and y and z are rational numbers from 0 to 1.

In some examples, set forth herein is a Li⁺ ion-conducting separator, wherein the separator includes a lithium sulfide characterized by Li₁₀Si_{0.5}Sn_{0.5}P₂S₁₂ and Li_{7.4}P_{1.6}S_{7.2}I.

In some examples, set forth herein is a Li⁺ ion-conducting separator, wherein the separator is a lithium sulfide characterized by Li₁₀Si_{0.5}Sn_{0.5}P₂S₁₂ and Li_{7.4}P_{1.6}S_{7.2}I.

In some examples, set forth herein is a Li⁺ ion-conducting separator, wherein the separator includes a lithium sulfide characterized by Li_{7.4}P_{1.6}S_{7.2}I.

In some examples, set forth herein is a Li⁺ ion-conducting separator, wherein the separator includes a borohydride selected from LBHI and LBHI-N.

In some examples, set forth herein is a Li⁺ ion-conducting separator, wherein the separator is a borohydride selected from LBHI and LBHI-N.

In some examples, set forth herein is a Li⁺ ion-conducting separator, wherein the separator is a pellet or a film. In some examples, the separator is a pellet. In some other examples, the separator is a film. In some other examples, the separator is a thin film.

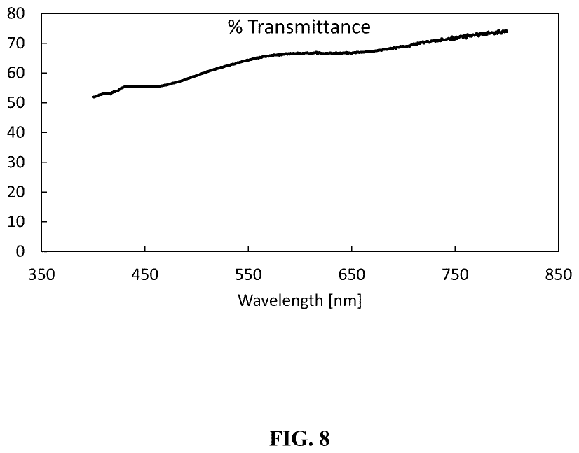

In some examples, set forth herein is a Li⁺ ion-conducting separator, wherein the separator has a transmission percentage that varies by less than ±10% over an area of at least 0.5 cm². The transmittance of samples was measured by Thermo Evolution 220 UV-Vis instrument with 60 mm integrating sphere. The UV-Vis spectra was collected in transmittance mode with a wavelength range 400-800 nm and 2 nm/sec scan speed. A baseline correction was performed before measurements using 100% T(no sample)/0%T(blocked sample) method. All samples were mirror-polished to 0.7 mm thick to eliminate surface scattering and thickness effect. Results of such a measurement on one sample are shown in FIG. 8.

In some examples, set forth herein is a Li⁺ ion-conducting separator, wherein the separator has a transmission percentage that varies by less than ±9% over an area of at least 0.5 cm².

In some examples, set forth herein is a Li⁺ ion-conducting separator, wherein the separator has a transmission percentage that varies by less than ±8% over an area of at least 0.5 cm².

In some examples, set forth herein is a Li⁺ ion-conducting separator, wherein the separator has a transmission percentage that varies by less than ±7% over an area of at least 0.5 cm².

In some examples, set forth herein is a Li⁺ ion-conducting separator, wherein the separator has a transmission percentage that varies by less than ±6% over an area of at least 0.5 cm².

In some examples, set forth herein is a Li⁺ ion-conducting separator, wherein the separator has a transmission percentage that varies by less than ±5% over an area of at least 0.5 cm².

In some examples, set forth herein is a Li⁺ ion-conducting separator, wherein the separator has a transmission percentage that varies by less than ±4% over an area of at least 0.5 cm².

In some examples, set forth herein is a Li⁺ ion-conducting separator, wherein the separator has a transmission percentage that varies by less than ±3% over an area of at least 0.5 cm².

In some examples, set forth herein is a Li⁺ ion-conducting separator, wherein the separator has a transmission percentage that varies by less than ±2% over an area of at least 0.5 cm².

In some examples, set forth herein is a Li⁺ ion-conducting separator, wherein the separator has a transmission percentage that varies by less than ±1% over an area of at least 0.5 cm².

In some examples, set forth herein is a Li⁺ ion-conducting separator, wherein the transmission coefficient is 0.2 +0.1 and the separator thickness is less than 1 mm.

In some examples, set forth herein is a Li⁺ ion-conducting separator, wherein the transmission coefficient is 0.3 +0.1 and the separator thickness is less than 1 mm.

In some examples, set forth herein is a Li⁺ ion-conducting separator, wherein the transmission coefficient is 0.4 +0.1 and the separator thickness is less than 1 mm.

In some examples, set forth herein is a Li⁺ ion-conducting separator, wherein the transmission coefficient is 0.5 +0.1 and the separator thickness is less than 1 mm.

In some examples, set forth herein is a Li⁺ ion-conducting separator, wherein the transmission coefficient is 0.6 +0.1 and the separator thickness is less than 1 mm.

In some examples, set forth herein is a Li⁺ ion-conducting separator, wherein the transmission coefficient is 0.7±0.1 and the separator thickness is less than 1 mm.

The In some examples, set forth herein is a Li⁺ ion-conducting separator, wherein the transmission coefficient is 0.8±0.1 and the separator thickness is less than 1 mm.

In some examples, set forth herein is a Li⁺ ion-conducting separator, wherein the transmission coefficient is 0.9±0.1 and the separator thickness is less than 1 cm.

In some examples, set forth herein is a Li⁺ ion-conducting separator, wherein the transmission coefficient is 0.2±0.1 and the separator thickness is less than 1 cm.

In some examples, set forth herein is a Li⁺ ion-conducting separator, wherein the transmission coefficient is 0.3±0.1 and the separator thickness is less than 1 cm.

In some examples, set forth herein is a Li⁺ ion-conducting separator, wherein the transmission coefficient is 0.4±0.1 and the separator thickness is less than 1 cm.

In some examples, set forth herein is a Li⁺ ion-conducting separator, wherein the transmission coefficient is 0.5±0.1 and the separator thickness is less than 1 cm.

In some examples, set forth herein is a Li⁺ ion-conducting separator, wherein the transmission coefficient is 0.6±0.1 and the separator thickness is less than 1 cm.

In some examples, set forth herein is a Li⁺ ion-conducting separator, wherein the transmission coefficient is 0.7±0.1 and the separator thickness is less than 1 cm. The In some examples, set forth herein is a Li⁺ ion-conducting separator,

wherein the transmission coefficient is 0.8±0.1 and the separator thickness is less than 1 cm.

In some examples, set forth herein is a Li⁺ ion-conducting separator, wherein the transmission coefficient is 0.9±0.1 and the separator thickness is less than 1 cm.

In some examples, set forth herein is a Li⁺ ion-conducting separator, wherein the transmission coefficient is 0.2±0.1 and the separator thickness is less than 1 μm.

In some examples, set forth herein is a Li⁺ ion-conducting separator, wherein the transmission coefficient is 0.3+0.1 and the separator thickness is less than 1 μm.

In some examples, set forth herein is a Li⁺ ion-conducting separator, wherein the transmission coefficient is 0.4±0.1 and the separator thickness is less than 1 μm.

In some examples, set forth herein is a Li⁺ ion-conducting separator, wherein the transmission coefficient is 0.5±0.1 and the separator thickness is less than 1 μm.

In some examples, set forth herein is a Li⁺ ion-conducting separator, wherein the transmission coefficient is 0.6±0.1 and the separator thickness is less than 1 μm.

In some examples, set forth herein is a Li⁺ ion-conducting separator, wherein the transmission coefficient is 0.7±0.1 and the separator thickness is less than 1 μm. The In some examples, set forth herein is a Li⁺ ion-conducting separator,

wherein the transmission coefficient is 0.8±0.1 and the separator thickness is less than 1 μm.

In some examples, set forth herein is a Li⁺ ion-conducting separator, wherein the transmission coefficient is 0.9±0.1 and the separator thickness is less than 1 μm.

In some examples, set forth herein is a Li⁺ ion-conducting separator, wherein the separator is transparent over an area of at least 1 cm². In some examples, the separator is transparent over an area of at least 1.5 cm². In some examples, the separator is transparent over an area of at least 2 cm². In some examples, the separator is transparent over an area of at least 2.5 cm². In some examples, the separator is transparent over an area of at least 3 cm². In some examples, the separator is transparent over an area of at least 3.5 cm². In some examples, the separator is transparent over an area of at least 4 cm². In some examples, the separator is transparent over an area of at least 4.5 cm². In some examples, the separator is transparent over an area of at least 5 cm².

In some examples, set forth herein is a Li⁺ ion-conducting separator, wherein the separator is translucent over an area of at least 1 cm². In some examples, the separator is translucent over an area of at least 1.5 cm². In some examples, the separator is translucent over an area of at least 2 cm². In some examples, the separator is translucent over an area of at least 2.5 cm². In some examples, the separator is translucent over an area of at least 3 cm². In some examples, the separator is translucent over an area of at least 3.5 cm². In some examples, the separator is translucent over an area of at least 4 cm². In some examples, the separator is translucent over an area of at least 4.5 cm². In some examples, the separator is translucent over an area of at least 5 cm².

In some examples, set forth herein is a Li⁺ ion-conducting separator, wherein the separator is translucent over an area of at least 64·π mm².

In some examples, set forth herein is a Li⁺ ion-conducting separator, wherein the separator is transparent over an area of at least 64·π mm².

In some examples, set forth herein is a Li⁺ ion-conducting separator, wherein the separator is transparent over an area of at least 0.5cm².

In some examples, set forth herein is a Li⁺ ion-conducting separator, wherein the separator is transparent over an area of at least 5 cm².

In some examples, set forth herein is a Li⁺ ion-conducting separator, wherein the separator is transparent over an area of at least 25 cm².

In some examples, set forth herein is a Li⁺ ion-conducting separator, wherein the separator is transparent over an area of at least 100 cm².

In some examples, set forth herein is a Li⁺ ion-conducting separator, wherein the separator is transparent over an area of at least 200 cm².

In some examples, set forth herein is a Li⁺ ion-conducting separator, wherein

the d₉₀ grain size ranges from 0.1 to 20 μm.

In some examples, set forth herein is a Li⁺ ion-conducting separator having a defect density from 1/m² to 1/mm². In some examples, there is only one defect per m². In some examples, there is only one defect per cm². In some examples, there is only one defect per mm². In some examples, there is only one defect per μm². In some examples, there is only one defect per 10nm².

In some examples herein, the solid-state electrolyte is a lithium-stuffed garnet electrolyte having a defect density less than 1/m². In some examples herein, the solid-state electrolyte is a lithium-stuffed garnet electrolyte having a defect density less than 1/cm². In some examples herein, the solid-state electrolyte is a lithium-stuffed garnet electrolyte having a defect density less than 1/mm². In some examples herein, the solid-state electrolyte is a lithium-stuffed garnet electrolyte having a defect density less than 1/ μm². In some examples herein, the solid-state electrolyte is a lithium-stuffed garnet electrolyte having a defect density less than 1/nm².

In some examples, set forth herein is a Li⁺ ion-conducting separator, wherein a scattering center density ranges from 1/m² to 1/mm². In some examples, there is only one scattering center per m². In some examples, there is only one scattering center per cm². In some examples, there is only one scattering center per mm². In some examples, there is only one scattering center per μm². In some examples, there is only one scattering center per nm2.

In some examples, set forth herein is a Li⁺ ion-conducting separator, wherein a geometric porosity from ranges 10 ppb to 6%.

In some examples, set forth herein is a Li⁺ ion-conducting separator, wherein an Archimedes porosity from ranges 10 ppb to 6%.

In some examples, set forth herein is a Li⁺ ion-conducting separator, wherein a density from 94%-99.9999% as measured by a 2D cross-section.

In some examples, set forth herein is a Li⁺ ion-conducting separator, wherein the separator is a pellet, monolith or thin film having a thickness less than 1 mm and greater than 10 nm.

In some examples, set forth herein is a Li⁺ ion-conducting separator, wherein the separator is a pellet, monolith or thin film having a thickness less than 1 cm and greater than 10 nm.

In some examples, set forth herein is a Li⁺ ion-conducting separator, wherein the separator is a pellet, monolith or thin film having a thickness less than 1 μm and greater than 10 nm.

In some examples, set forth herein is a Li⁺ ion-conducting separator, having a Geometric porosity less than 5% by volume.

In some examples, set forth herein is a Li⁺ ion-conducting separator, having an Archimedes porosity less than 5% by volume.

In some examples, set forth herein is a Li⁺ ion-conducting separator, having a Archimedes porosity less than 1% by volume.

In some examples, set forth herein is a Li⁺ ion-conducting separator, wherein the D₉₀ grain is from 0.4 μm to 20 μm.

In some examples, set forth herein is a Li⁺ ion-conducting separator, wherein the separator consists essentially of more than 95% of a primary phase when measured by a quantitative XRD.

In some examples, set forth herein is a Li⁺ ion-conducting separator, wherein the separator consists essentially of more than 98% of a primary phase when measured by a quantitative XRD.

In some examples, set forth herein is a Li⁺ ion-conducting separator, wherein the separator consists essentially of more than 99% of a primary phase when measured by a quantitative XRD.

In some examples, set forth herein is a Li⁺ ion-conducting separator, wherein the separator consists essentially of more than 99.9% of a primary phase when measured by a quantitative XRD.

In some examples, set forth herein is a Li⁺ ion-conducting separator which includes: a lithium-stuffed garnet oxide characterized by the formula LiᵤLaᵥZrₓO_{y}.zTa₂O₅, wherein
u is a rational number from 4 to 10;
v is a rational number from 2 to 4;
x is a rational number from 1 to 3;

y is a rational number from 10 to 14; and
z is a rational number from 0 to 1;
wherein u, v, x, y, and z are selected so that the lithium-stuffed garnet oxide is charge neutral.

In some examples, set forth herein is a Li⁺ ion-conducting separator which includes a lithium-stuffed garnet oxide characterized by the formula LiᵤLaᵥZrₓO_{y}.zNb₂O₅, wherein
u is a rational number from 4 to 10;
v is a rational number from 2 to 4;
x is a rational number from 1 to 3;
y is a rational number from 10 to 14; and
z is a rational number from 0 to 1;
wherein u, v, x, y, and z are selected so that the lithium-stuffed garnet oxide is charge neutral.

In some examples, set forth herein is a Li⁺ ion-conducting separator which includes a lithium-stuffed garnet oxide characterized by the formula LiᵤLaᵥZrₓO_{y}.zGa₂O₃, wherein
u is a rational number from 4 to 10;
v is a rational number from 2 to 4;
x is a rational number from 1 to 3;
y is a rational number from 10 to 14; and
z is a rational number from 0 to 1;
wherein u, v, x, y, and z are selected so that the lithium-stuffed garnet oxide is charge neutral.

In some examples, set forth herein is a Li⁺ ion-conducting separator which

includes a lithium-stuffed garnet oxide characterized by the formula LiᵤLaᵥZrₓO_{y}.zTa₂O₅b.Al₂O₃, wherein
u is a rational number from 4 to 10;
v is a rational number from 2 to 4;
x is a rational number from 1 to 3;
y is a rational number from 10 to 14; and
z is a rational number from 0 to 1;
b is a rational number from 0 to 1;
wherein z+b≤1
wherein u, v, x, y, and z are selected so that the lithium-stuffed garnet oxide is charge neutral.

In some examples, set forth herein is a Li⁺ ion-conducting separator which

includes a lithium-stuffed garnet oxide characterized by the formula LiᵤLaᵥZrₓO_{y}.zNb₂O₅.bAl₂O₃, wherein
u is a rational number from 4 to 10;
v is a rational number from 2 to 4;
x is a rational number from 1 to 3;
y is a rational number from 10 to 14; and
z is a rational number from 0 to 1;
b is a rational number from 0 to 1;
wherein z+b≤1
wherein u, v, x, y, and z are selected so that the lithium-stuffed garnet oxide is charge neutral.

In some examples, set forth herein is a Li⁺ ion-conducting separator which includes a lithium-stuffed garnet oxide characterized by the formula LiᵤLaᵥZrₓO_{y}.zGa₂O₃bAl₂O₃, wherein
u is a rational number from 4 to 10;
v is a rational number from 2 to 4;
x is a rational number from 1 to 3;
y is a rational number from 10 to 14; and
z is a rational number from 0 to 1;
b is a rational number from 0 to 1;
wherein z+b≤1
wherein u, v, x, y, and z are selected so that the lithium-stuffed garnet oxide is charge neutral.

In some examples, set forth herein is a Li⁺ ion-conducting separator, wherein the lithium ion conductivity is greater than 10⁻⁴S/cm at 25° C.

In some examples, set forth herein is a Li⁺ ion-conducting separator, wherein the lithium interfacial area-specific resistance is less than 20 Ωcm² at 25° C.

In some examples, set forth herein is a Li⁺ ion-conducting separator, wherein the translucent properties of the separators are uniform over a surface area of at least 100 nm².

### III. Thin Films

In certain examples, the translucent or transparent film disclosed herein is a thin film having a thickness that is between about 10 nm to 100 μm.

In some examples, the translucent or transparent film has a thickness from about 10 μm to about 100 μm. In some other of the methods disclosed herein, these film have a thickness from about 20 μm to about 100 μm. In certain of the methods disclosed herein, the film has a thickness from about 30 μm to about 100 μm. In certain other of the methods disclosed herein, the film has a thickness from about 40 μm to about 100 μm. In yet other methods disclosed herein, the film has a thickness from about 50 μm to about 100 μm. In still other methods disclosed herein, the film has a thickness from about 60 μm to about 100 μm. In yet some other methods disclosed herein, the film has a thickness from about 70 μm to about 100 μm. In some of the methods disclosed herein, the film has a thickness from about 80 μm to about 100 μm. In some other of the methods disclosed herein, the film has a thickness from about 90 μm to about 100 μm. In some of the methods disclosed herein, the film has a thickness from about 10 μm to about 90 μm. In some other of the methods disclosed herein, the film has a thickness from about 20 μm to about 80 μm. In certain of the methods disclosed herein, the film has a thickness from about 30 μm to about 70 μm. In certain other of the methods disclosed herein, the film has a thickness from about 40 μm to about 60 μm. In yet other methods disclosed herein, the film has a thickness from about 50 μm to about 90 μm. In still other methods disclosed herein, the film has a thickness from about 60 μm to about 90 μm. In yet some other methods disclosed herein, the film has a thickness from about 70 μm to about 90 μm. In some of the methods disclosed herein, the film has a thickness from about 80 μm to about 90 μm. In some other of the methods disclosed herein, the film has a thickness from about 30 μm to about 60 μm. In some examples, the films have a thickness of about 1-150 μm. In some of these examples the films has a thickness of about 1 μm. In some other examples the films has a thickness of about 2 μm. In certain examples, the films has a thickness of about 3 μm. In certain other examples the films has a thickness of about 4 μm. In some other examples the films has a thickness of about 5 μm. In some examples the films has a thickness of about 6 μm. In some of these examples the films has a thickness of about 7 μm. In some examples the films has a thickness of about 8 μm. In some other examples the films has a thickness of about 9 μm. In certain examples the films has a thickness of about 10 μm. In some of these examples the films has a thickness of about 11 μm. In some other examples the films has a thickness of about 12 μm. In certain examples, the films has a thickness of about 13 μm. In certain other examples the films has a thickness of about 14 μm. In some other examples the films has a thickness of about 15 μm. In some examples the films has a thickness of about 16 μm. In some of these examples the films has a thickness of about 17 μm. In some examples the films has a thickness of about 18 μm. In some other examples the films has a thickness of about 19 μm. In certain examples the films has a thickness of about 20 μm.

In some examples, the translucent or transparent film is circularly-shaped and has a diameter of about 10 mm. In some examples, the diameter, is 1, 2, 3, 4, 5, 6, 7, 8, 9, 10, 11, 12, 13, 14, 15, 16, 17, 18, 19 or 20 mm.

In some examples, the translucent or transparent film is rectangularly-shaped and has a long edge length of about 10 cm. In some examples, the longer edge length, is 1, 2, 3, 4, 5, 6, 7, 8, 9, 10, 11, 12, 13, 14, 15, 16, 17, 18, 19 or 20 cm.

### IV. Methods of Making Separators

In some examples, set forth herein is method for making a translucent and flexible Flexible Li⁺ ion-Conducting Separator, wherein the method comprises:
providing an inorganic material;
milling the inorganic material to form a milled inorganic material;
annealing the milled inorganic material to form an annealed inorganic material;
pressing the annealed inorganic material; and
heating the inorganic material.

In some examples of the methods set forth herein, the inorganic material is LiₓLa_{y}Zr_{z}Oₜ.qAl₂O₃, wherein 4<x<10, 1<y<4, 1<z<3, 6<t<14, 0≤q≤1. In some other examples, the inorganic material is selected from LPSI, LSS, SLOPS, LSTPS, SLOBS, LATS, and combinations thereof. In yet other examples, the inorganic material is selected from LBHI, LBNHI, LBHCl, LBNHCl, LBHBr, LBNHBr and combinations thereof. In yet other examples, the inorganic material is LiₐSi_{b}Sn_{c}P_{d}SₑO_{f}, wherein 2≤a≤8, b+c=1, 0.5≤d≤2.5, 4≤e≤12, and 0<f≤10. In other examples, the inorganic material is Li_{g}AsₕSnⱼSₖOₗ, wherein 2≤g≤6, 0≤h≤1, 0≤j≤1, 2≤k≤6, and 0≤1≤10. In some other examples, the inorganic material is LiₘPₙSₚI_{q}, wherein 2≤m≤6, 0≤n≤1, 0≤p≤1, 2≤q≤6. In some other examples, the inorganic material is a mixture of (Li₂S): (P₂S₅) having a molar ratio from about 10:1 to about 6:4 and LiI, wherein the ratio of [(Li₂S):(P₂S₅)]:LiI is from 95:5 to 50:50. In some other examples, the inorganic material is a mixture of LiI and Al₂O₃. In some other examples, the inorganic material is Li3N. In some other examples, the inorganic material is a LPS+X, wherein X is selected from Cl, I, or Br. In some other examples, the inorganic material is vLi₂S+wP₂S₅+yLiX, vLi₂S+wSiS₂+yLiX, vLiBH₄+wLiX+yLiNH₂, or vLi₂S+wB₂S₃+yLiX, wherein coefficients v, w, and y are rational numbers from 0 to 1. In some other examples, the inorganic material is a mixture of LiBH₄ and LiX wherein X is selected from Cl, I, or Br. In these examples, X is selected from Cl, I, or Br.

In some examples of the methods set forth herein, the milling the inorganic material to form a milled inorganic material includes milling until the inorganic material has a d₅₀ particle size of 100 nm to 1000 nm.

In some examples, the annealing the milled inorganic material to form an annealed inorganic material includes heating the inorganic material. In some examples, the heating the inorganic material is in a controlled atmosphere. In some examples, the heating includes heating the inorganic material to at least 400, 500, 600, 700, 800, 900, or 1000° C. In some examples, the heating includes heating the inorganic material to at least 400, 500, 600, 700, 800, 900, or 1000° C. in an atmosphere having Argon, hydrogen, water, or a combination thereof.

In some examples, the pressing the annealed inorganic material and heating the inorganic material is accomplished simultaneously. In some examples, the pressing the annealed inorganic material precedes the heating the inorganic material. In some examples, the pressing the annealed inorganic material includes pressing to at least 100 pounds per square inch (PSI). In some examples, the pressing the annealed inorganic material includes pressing to at least 1000 pounds per square inch (PSI). In some examples, the pressing the annealed inorganic material includes pressing to at least 10,000 pounds per square inch (PSI). In some examples, the heating the annealed inorganic material includes heating to at least 500° C. In some examples, the pressing the annealed inorganic material includes heating to at least 750° C. In some examples, the heating the annealed inorganic material includes heating to at least 900° C. In some examples, the pressing the annealed inorganic material includes heating to at least 1000° C. In some examples, the heating the annealed inorganic material includes heating to at least 1200° C. In some examples, the pressing the annealed inorganic material includes heating to at least 1500° C. In some examples, the heating the annealed inorganic material includes heating to at least 17000° C. In some examples, the pressing the annealed inorganic material includes heating to at least 2000° C. In certain examples, the heating, and/or pressing is performed for 15 seconds, 30 seconds, 45 seconds, or 60 seconds. In certain examples, the heating, and/or pressing is performed for about 1 minute, about 2minutes, about 5 minutes, or about 10 minutes.

In some examples, the method comprises melting an ion-conductor material or combination of ion-conductor materials or precursors to ion conductor materials and moulding, flowing, or pressing the melt into shape. In some examples, the method comprises melting an ion-conductor material or combination of ion-conductor materials or precursors to ion conductor materials and moulding the melt into shape. In some examples, the method comprises melting an ion-conductor material or combination of ion-conductor materials or precursors to ion conductor materials and flowing the melt into shape. In some examples, the method comprises melting an ion-conductor material or combination of ion-conductor materials or precursors to ion conductor materials and pressing the melt into shape. In some examples, the method comprises casting a powder of inorganic ion conductor and optionally a polymer into sheets. In some examples, the method further comprises calendering, densifying, laminating, or pressing the cast film. In some examples, the method includes polishing or cutting a sintered or heated material to reduce its thickness.

### Green Films

In some examples, set forth herein are sintered electrolyte films. Prior to a heat treatment of a film having an inorganic and organic component (e.g., polymer), the film is referred to as a “green film.” In some examples, the inorganic electrolyte is lithium-stuffed garnet powder, lithium-stuffed garnet chemical precursors, a sulfide electrolyte, or a combination thereof. In some examples, the inorganic electrolyte is a LIRAP or LBHI. In some examples, these films are extruded in layers or deposited or melt-cast or laminated onto other electrolytes in order to build up several layers of a composite electrolyte. In some examples, multiple green films are stacked and laminated prior to sintering. In some examples, these films are extruded as slurries that optionally include additional components. In some examples, these additional components include at least one member selected from a binder, a solvent, a dispersant, or combinations thereof. In some examples, the solid loading is at least 50% by volume. In some examples, the film thickness is less than 100 μm.

In some examples, the dispersant in the green film is a commercially available dispersant.

In some examples, the composite electrolytes films are extruded onto a substrate. In certain examples, the substrate is a polymer, a metal foil, or a metal powder. In some of these examples, the substrate is a metal foil. In some other examples, the substrate is a metal powder. In some of these examples, the metal is selected from Ni, Cu, Al, steel, alloys, or combinations thereof.

In some examples, the green films have a film thickness less than 75 μm and greater than 10 nm. In some examples, these films have a thickness less than 50 μm and greater than 10 nm. In some examples, the films include solid particles which are less than 5 μm at the particles maximum physical dimension (e.g., diameter for a spherical particle). In some examples, the films have a median solid particle grain size of between 0.1 μm to 10 μm. In other examples, the films are not adhered to any substrate. These films not adhered to any substrate are referred to as self-supporting or free standing.

In some examples, the electrolytes green films have a thickness from about 10 μm to about 100 μm. In some other of the methods disclosed herein, these film have a thickness from about 20 μm to about 100 μm. In certain of the methods disclosed herein, the film has a thickness from about 30 μm to about 100 μm. In certain other of the methods disclosed herein, the film has a thickness from about 40 μm to about 100 μm. In yet other methods disclosed herein, the film has a thickness from about 50 μm to about 100 μm. In still other methods disclosed herein, the film has a thickness from about 60 μm to about 100 μm. In yet some other methods disclosed herein, the film has a thickness from about 70 μm to about 100 μm. In some of the methods disclosed herein, the film has a thickness from about 80 μm to about 100 μm. In some other of the methods disclosed herein, the film has a thickness from about 90 μm to about 100 μm. In some of the methods disclosed herein, the film has a thickness from about 10 μm to about 90 μm. In some other of the methods disclosed herein, the film has a thickness from about 20 μm to about 80 μm. In certain of the methods disclosed herein, the film has a thickness from about 30 μm to about 70 μm. In certain other of the methods disclosed herein, the film has a thickness from about 40 μm to about 60 μm. In yet other methods disclosed herein, the film has a thickness from about 50 μm to about 90 μm. In still other methods disclosed herein, the film has a thickness from about 60 μm to about 90 μm. In yet some other methods disclosed herein, the film has a thickness from about 70 μm to about 90 μm. In some of the methods disclosed herein, the film has a thickness from about 80 μm to about 90 μm. In some other of the methods disclosed herein, the film has a thickness from about 30 μm to about 60 μm. In some examples, the films have a thickness of about 1-150 μm. In some of these examples the films has a thickness of about 1 μm. In some other examples the films has a thickness of about 2 μm. In certain examples, the films has a thickness of about 3 μm. In certain other examples the films has a thickness of about 4 μm. In some other examples the films has a thickness of about 5 μm. In some examples the films has a thickness of about 6 μm. In some of these examples the films has a thickness of about 7 μm. In some examples the films has a thickness of about 8 μm. In some other examples the films has a thickness of about 9 μm. In certain examples the films have a thickness of about 10 μm. In certain examples the films have a thickness of about 11 μm. In certain examples the films have a thickness of about 12 μm. In certain examples the films have a thickness of about 13 μm. In certain examples the films have a thickness of about 14 μm. In certain examples the films have a thickness of about 15 μm. In certain examples the films have a thickness of about 16 μm. In certain examples the films have a thickness of about 17 μm. In certain examples the films have a thickness of about 18 μm. In certain examples the films have a thickness of about 19 μm. In certain examples the films have a thickness of about 20 μm.

In some examples, the green electrolytes films set forth herein include an inorganic electrolyte combined with at least one or more polymers. In some of these examples, the polymers include, but are not limited to, polyethylene oxide (PEO), polypropylene oxide (PPO), PEO-PPO block co-polymers, styrene-butadiene, polystyrene (PS), acrylates, diacrylates, methyl methacrylates, silicones, acrylamides, t-butyl acrylamide, styrenics, t-alpha methyl styrene, acrylonitriles, vinyl acetates, polypropylene (PP), polyvinyl butyral (PVB), polyvinyl pyrrolidone (PVP), atactic polypropylene (aPP), isotactive polypropylene ethylene propylene rubber (EPR), ethylene pentene copolymer (EPC), polyisobutylene (PIB), styrene butadiene rubber (SBR), polyolefins, polyethylene-co-poly-1-octene (PE-co-PO); PE-co-poly (methylene cyclopentane), (PE-co-PMCP), stereoblock polypropylenes, polypropylene polymethylpentene, polyethylene (e.g., low density linear polyethylene), polybutadiene, copolymer and combinations thereof.

In some examples, the methods here include batching raw precursor material as follows: LiOH, Al(NO₃)₃.9H₂O, ZrO₂, and La₂O₃ are gathered in quantities corresponding to molar amounts of the final Li-stuffed garnet setter plate final composition (Li_{A}La_{B}M′_{c}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E<2, 10<F<13, e.g., Li₇La₃Zr₂O₁₂), as described above and as also described in various experimental examples of U.S. Patent Application Publication No. 2015-0099190 A1, the entire contents of which are herein incorporated by reference in its entirety for all purposes. In one embodiment, precursor materials are combined in proportions that, when reacted, produce a composition of Li₇Li₃Zr₂O₁₂ or Li₇Li₃Zr₂O₁₂ (0.1-1.0) Al₂O₃. The precursor materials are dried at 120° C. for at least 45 minutes. The dried precursor materials mixed and are optionally in some embodiments milled in a ball mill between 6 and 8 hours using, in some examples, 0.3 mm yttria-stabilized zirconium oxide grinding media beads. The result is a particle size distribution of precursor materials with a d₅₀ of approximately 100 nm. In some examples, the result is a particle size distribution of precursor materials with a d₅₀ of approximately 100 nm to 600 nm. The precursor materials are optionally crushed using a Retzsch mill and sieved using a 40 mesh sieve for 5 minutes. The precursor materials are then placed in an alumina crucible, covered, and calcined 224 at about 900° C. (or 400 to 1200° C.) for approximately 6 hours (or 2, 4, 6, or 8 hours). The calcined product is then crushed with, for example, a mortar and pestle although other grinding and milling mechanisms may be used. The calcined and crushed precursor materials are then attrition milled by suspending approximately 62.5 weight % solids and 10 weight % dispersant, with a suspension media such as isopropyl alcohol making up the balance of the weight (i.e., approximately 27.5 weight %). In some examples, these steps includes about 60 g of garnet, about 30 g of solvent, and about 10 g of dispersant. In some examples, the solvent is isopropanol and butanol.

Examples of dispersants, used to facilitate suspension of the calcined and crushed precursor materials in the isopropyl alcohol include, but are not limited to, phosphate esters, RHODOLINE™ 4160, rhodoline 4188, Phoschem R6, phoschem PD, phospholan-131™, esters such as fish oil, BYK™ 22124, surfactants, fluorosurfactants, polyvinylpyridine (PVP), polyvinyl butadiene (PVB), TRITON™, phospholan-131™, BYK™ 22124, BYK™ 22416, Hypermer KD1™, polyalkylene amine such as Hypermer KD2, acrylic polymers such as Hypermer KD6™, Hypermer KD7™ and others, such as Dispersbyk-118, BYK™ 22146, Hypermer KD7™. While isopropyl alcohol is used in this example, other solvents may also be used including toluene, ethanol, combinations thereof (i.e., toluene:ethanol::4:1) and others. The attrition milling may be performed for approximately eight hours with an inert zirconia grinding media to produce a d₅₀ particle size distribution from approximately 100 nm to approximately 1 μm (e.g., 300 nm to approximately 400 nm).

The above materials can be formulated as a slurry. The slurry is optionally centrifuged at 2000 rpm for 1-12 hours. If, however, the slurry is centrifuged, the supernatant is drained and the percentage of solids in the remaining slurry is determined. If the slurry is not centrifuged, the solid loading is determined and adjusted appropriately. In some examples the percentage of solids in the slurry is between approximately 40 weight %, 50 weight % 60 weight % or 70 weight %. In some examples, the slurry is adjusted or prepared so that the slurry includes, in relative amounts respectively, approximately 60 g of garnet, approximately 100 g of solvent, approximately 4 g of binder (PVB) and approximately 1 g of plasticizer (e.g., dibutyl phthalate, benzyl dutyl phthalate).

In some examples, the slurry is mixed with a 4 weight % solution of polyvinyl butyral binder in toluene in a weight ratio of 1:1. This mixture is then dried, mechanically crushed (for example, using a mortar and pestle), and sieved 276, for example, using an 80 mesh sieve. Resulting from 276 is a slurry having approximately 100 g of garnet, 4 g of binder, and 1 g of plasticizer.

In some examples, the green film slurry used to make a sintered film includes about 50 wt % powder, 47.5 wt % solvent, 2 wt % binder and 0.5 wt % plasticizer. Binders and solvents are described herein, above and below. The combined components are then mixed and/or optionally milled for approximately 8 hours (e.g., by hand stirring although the components can be combined using appropriate mixer or blender). The mixed components are placed on a hot plate or oven to remove the solvents. Other methods to remove solvents such as ROTO-VAP™ or spray drying could also be used.

In some examples, the green film is then placed between, or on top of, commercially available (e.g., platinum) setter plates (or alternatively on a single substrate) and sintered 284 in a furnace at from approximately 500° C. to approximately 1300° C. (and preferably from 1075° C. to approximately 1150° C.) in an argon atmosphere, for approximately three hours to approximately six hours. In some examples, the setter plate is removed from the furnace at temperature to air quench. In some other examples, the setter plate is left in the oven to cool over many hours. The ramp rate of the furnace is from about 1° C./min to about 10° C./min.

In some examples, an unsintered thin film is prepared or cast so that it can be placed between setter plates in a subsequent sintering procedure. This process includes a slurry preparation step in which a combination of milled Li-stuffed garnet powder that is a product of the above materials with one or more solvents, a binder, and a plasticizer (such as dibutyl phthalate).

In some examples, the slurry includes a solvent selected from isopropanol, water, butanol, tetrahydrofuran (THF), with a binder (e.g., PVB), a plasticizer. In some examples, the solvent includes about 10-30% w/w isopropanol, 1-10% w/w water, 1-10% w/w butanol, and 10-30% w/w tetrahydrofuran (THF) [e.g. 100 grams garnet, 12 grams binder, 12 grams DBP, 20-30 grams solvent]. In some examples, the solvent includes about 20-30% w/w isopropanol, 3-6% w/w water, 3-6% w/w butanol, and 20-30% w/w tetrahydrofuran (THF). In some examples, the binder is 5% w/w. In some examples, the plasticizer is 5% w/w. In these examples, the garnet or calcined precursor materials represents the remaining % w/w (e.g., 40, 50, or 60% w/w). In some examples, a dispersant is used during the milling process. In some examples, the dispersant is a phosphate ester. In some examples, the plasticizer is dibutyl thalate or benzyl butyl phthalate. In some examples, the solvent is butanol and THF. In some examples, the solvent is butanol, water and THF. In some examples, the solvent is butanol, water, toluene, and THF. In some examples, the solvent is butanol and toluene. In some examples, the solvent is butanol, water and THF.

Examples of solvents include toluene, ethanol, diacetone alcohol, and combinations thereof. Other examples of solvents include combinations of isopropanol, butanol, and toluene. Other examples of solvents include methanol, ethanol, isopropanol, butanol, pentanol, hexanol, toluene, xylene, tetrahydrofuran, toluene: ethanol, acetone, N-methyl-2-pyrrolidone (NMP) diacetone alcohol, ethyl acetate, acetonitrile, hexane, nonane, dodecane, methyl ethyl ketone (MEK), and combinations thereof.

Examples of binders, used to facilitate the adhesion between the Li-stuffed garnet particles, include, but are not limited to, polypropylene (PP), polyvinyl butyral (PVB), poly ethyl methacrylate (PMMA), polyvinyl pyrrolidone (PVP), atactic polypropylene (aPP), isotactive polypropylene ethylene propylene rubber (EPR), ethylene pentene copolymer (EPC), polyisobutylene (PIB), styrene butadiene rubber (SBR), polyolefins, polyethylene-copoly-1-octene (PE-co-PO); PE-co-poly (methylene cyclopentane) (PE-co-PMCP); stereo block polypropylenes, polypropylene polymethylpentene copolymer, poly propylene carbonate, methyl methacrylate, ethyl methacrylate, and silicone. Other binders include binder is selected polypropylene (PP), atactic polypropylene (aPP), isotactic polypropylene (iPP), ethylene propylene rubber (EPR), ethylene pentene copolymer (EPC), polyisobutylene (PIB), styrene butadiene (SBR), polyolefins, polyethylene-co-poly-1-octene (PE-co-PO), PE-co-poly (methylene cyclopentene) (PE-co-PMCP), stereoblock polypropylenes, polypropylene polymethyl pentene, polyethylene oxide (PEO), PEO block copolymers, silicone, and combinations thereof.

In order to make unsintered tape-cast films (i.e., green films), the following steps may be employed. The garnet precursors are combined in amounts such that after sintering, the ratio of chemical reactants matches the ratio of the constituent components in the final garnet electrolyte film assuming no mass loss. These precursors are mixed and milled. After about 8 hours, a plasticizer is added in an amount of approximately 5 weight % of the combined components. Solvent is added in an amount of approximately 5-50 weight % of the combined components. Mixing and milling may optionally continue after the addition of the plasticizer and solvent for another 12 hours. After the completion of the mixing and milling, a resulting slurry is filtered to remove any remaining grinding media and agglomerates or to ensure the homogeneity of the particle sizes therein. The slurry can then be cast, e.g., by doctor blading, to prepare a thin film of unsintered garnet.

### Sintering Methods

In some examples, the methods set forth herein include a sintering step. In some of these examples, sintering includes heating the electrolyte film or powder in the range from about 850 C to about 1200° C. for about 1 to about 720 minutes and in atmosphere having an oxygen partial pressure between 1 atm to 1e-15 atm.

In some examples, the methods set forth herein include a sintering step. In some of these examples, sintering includes heating the electrolyte film, powder, or precursor to about 1100° C. for about one to four hours.

Sintering, in some examples, includes sintering by forging, field-assisted sintering, spark plasma sintering, hot-press sintering, sintering with the addition of secondary phases to control grain growth, liquid phase sintering or a combination thereof.

### F. EXAMPLES

Electron microscopy was performed in a FEI Quanta SEM, a Helios 600i, or a Helios 660 FIB-SEM, though equivalent tools may be substituted. XRD was performed in a Bruker D8 Advance ECO or a Rigaku Miniflex 2. EIS was performed with a Biologic VMP3, VSP, VSP-300, SP-150, or SP-200. Optical imaging was performed with an optical camera. DC cycling was performed with Arbin BT-2043, or BT-G, though it is understood that equivalent tools may be substituted.

### Example 1

Method of Making Translucent and Flexible Li⁺ Ion-Conducting Separator

In this example, a mixture of Li₂S:P₂S₅:LiI (herein “LPSI”) was mixed for 1-24 hours at 100-300 rpm in an inert and hermetic milling vessel with inert media, in an 60-75:10-25:5-30 mole ratio. The resulting mixture was then sieved and annealed in an inert and hermetic vessel at a temperature of 175-500° C. for a time from 180-600 min. The heat treated mixture was removed from the annealing vessel and sieved. The sieved material was hot pressed at a pressure of 2-20 MPa line pressure in a hydraulic press and heated at 150-400° C. for 10-600 min. All processing was performed in an inert atmosphere. This process formed the LPSI translucent separator.

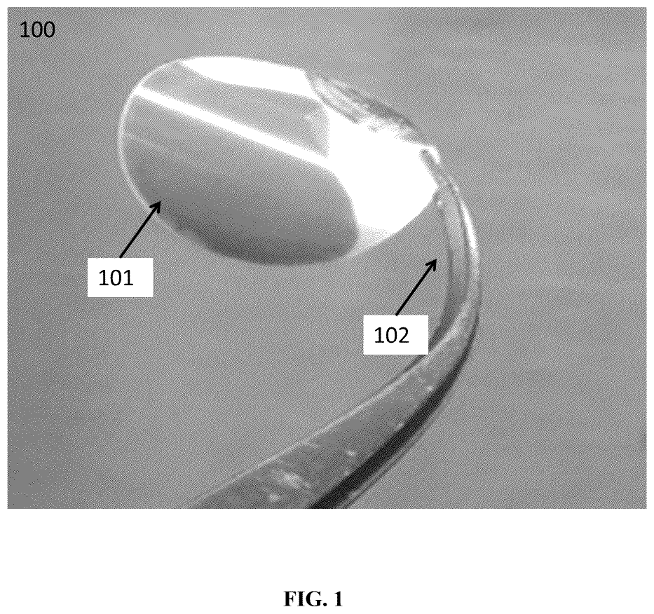

A translucent separator is shown optically (100) in FIG. 1 as a circular-shaped translucent film of LPSI (101). The film (101) is shown in FIG. 1 supported by tweezers (102). The film (101) has a diameter of approximately 1 cm. The film is flexible and bends under its own weight, as shown in FIG. 1.

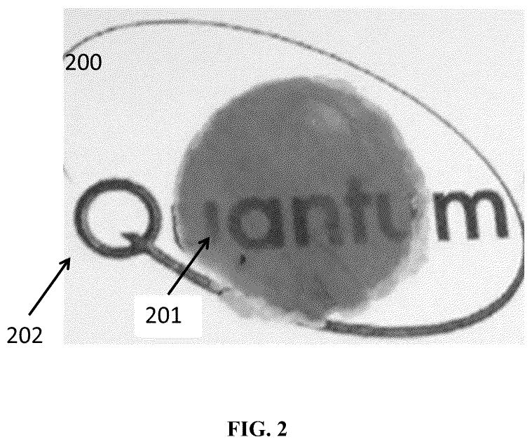

As shown in FIG. 2, the translucent separator is overlaid over a piece of paper with the word “Quantum” written on it (200). The film (201) is shown in FIG. 2 supported on top of the paper (202). The film (201) has a diameter of approximately 1 cm.

### Example 2

### Spark-Plasma-Synthesis (SPS) Method of Making Li⁺ Ion-Conducting Separator

In this method, lithium-stuffed garnet calcined powders were batched. Specifically, powders with small particle size of LiOH, La₂O₃, ZrO₂, and aluminum nitrate nonahydrate were dried and well mixed in a weight ratio of about 1.8:5.8:2.9:1. The powder is calcined in alumina crucibles at between 750-1100° C. for 2-20 hours and then crushed. The crushed calcined powder is loaded into a die and the die is loaded into an SPS chamber. The powder is sintered under a pressure of 1-200 MPa at a temperature of 750-1200° C. for 1-660 min. The temperature ramp rate varies from 5-100° C./min. Current and voltage are supplied according to a closed-loop feedback control to hit the desired temperature.

The green film was sintered used an SPS apparatus Thermal Technology SPS25-10. The SPS apparatus provides uniaxial pressure to the sintering film while it is sintering. SPS also provides an electrical field for fast densification of the sintering film.

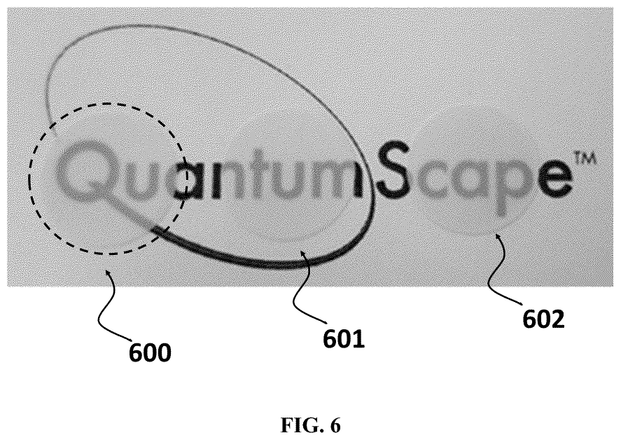

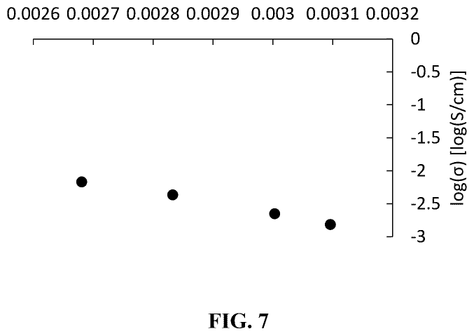

As shown in FIG. 6, a transparent separator was produced by the method in this Example. FIG. 6 shows three transparent separators, labeled as 600, 601, and 602 respectively. The area in FIG. 6 showing transparent separator, 600, is outlined to highlight it.

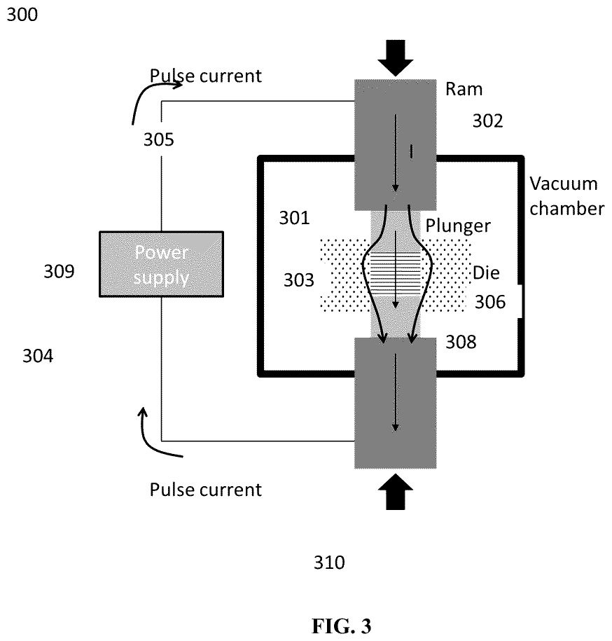

As shown in FIG. 3 the SPS apparatus (300) includes a list of components. Included are a vacuum chamber (301) which allows for atmosphere control around the sintering film. Also included are rams (302) and (303), included in a graphite die case (306), which are used to apply pressure to powder (303). The SPS also includes a means for running a current (305) and (309). The SPS also includes a thermocouple (308) for monitoring and controlling temperature of the sintering film.

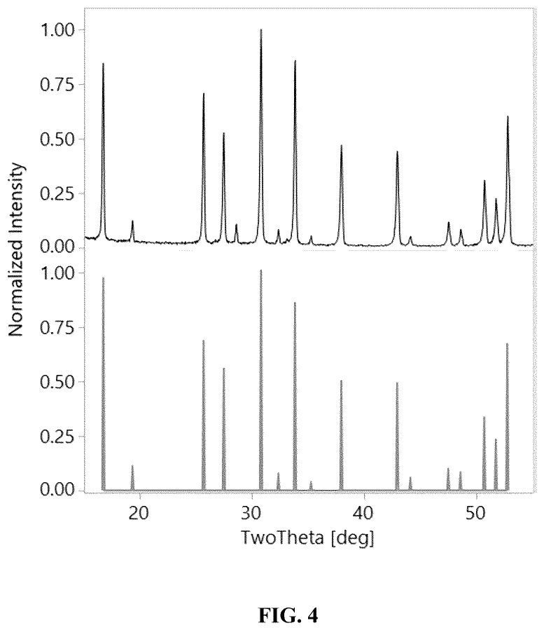

As shown in FIG. 4, the material sintered according to the SPS method of this Example retained the garnet crystal phase. One sintered sample was analyzed by XRD and is compared to a garnet crystal phase reference pattern.

Electrochemical Impedance Spectroscopy (EIS) was performed on the SPS films to measure the Area-Specific Resistance (ASR) of each sample prepared by the SPS method in this Example. EIS was performed by attaching a Biologic VMP3 to lithium contacts deposited on two sides of a sample. An AC voltage of 25 mV rms is applied across a frequency of 300 kHz-0.1 mHz while the current is measured. As is known in the art, EIS allows partitioning of the ASR into bulk and interfacial ASR by resolving two semicircles in a Nyquist plot. An interfacial ASR (ASR_{interface}) is calculated from the interfacial resistance (R_{interface}) via ASR_{interface}=R_{interface}*A/2 where A is the area of the electrodes in contact with the separator and the factor of 2 accounts for 2 interfaces, assuming they are symmetric.

Six (6) samples were prepared by the method of this Example, the EIS test results at room temperature which are shown in Table 1, below

TABLE 1

| Sample (Room | | | ASR_{interface} |
|---|---|---|---|
| temperature) | Bulk [Ω] | Interface [Ω] | [Ω cm²] |
| SAMPLE 1 | 528.6 | 127.7 | 18.2 |
| SAMPLE 2 | 510.7 | 173.0 | 24.7 |
| SAMPLE 3 | 493.1 | 192.7 | 27.5 |
| SAMPLE 4 | 488.2 | 125.2 | 17.9 |
| SAMPLE 5 | 431.2 | 216.5 | 30.9 |
| SAMPLE 6 | 422.2 | 93.4 | 13.3 |

### Example 3

### Electrochemical Cycling of Separators Prepared From Example 2

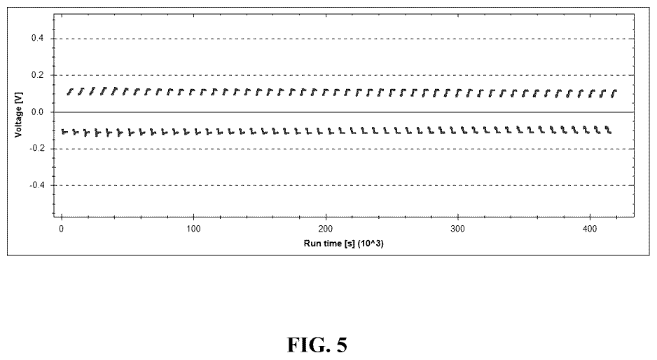

Separators were placed in a symmetric electrochemical cell with Li-metal electrodes on both sides of the samples. A current of 2 mA/cm² was applied to pass 2 mAh/cm² (about 10 μm) of lithium in one direction, then the polarity of current was reversed to pass 2 mAh/cm² (about 10 μm) of lithium in the opposite direction. Voltage was monitored during the test, and a plot of voltage versus time for the first 50 cycles is shown in FIG. 5. The sample was maintained at 50° C. during the test and a moderate amount of pressure is applied to maintain contact between lithium and the separator.

To prepare the sample for electrochemical measurement, after sintering, the sample surfaces were planarized and cleaned. Lithium was applied to each side in a manner as to obtain a low interfacial impedance. All processing was done in an inert atmosphere.

### Example 4

### Electrochemical Cycling of Separators Prepared From Example 2

FIG. 8 shows a plot of transmission versus wavelength for a translucent lithium-stuffed garnet separator, prepared according to Example 2. The transmittance of samples was measured by Thermo Evolution 220 UV-Vis instrument with 60 mm integrating sphere. The UV-Vis spectra was collected in transmittance mode with a wavelength range 400-800 nm and 2 nm/sec scan speed. A baseline correction was performed before measurements using 100%T(no sample)/0% T(blocked sample) method. All samples were mirror-polished to 0.7 mm thick to eliminate surface scattering and thickness effects.

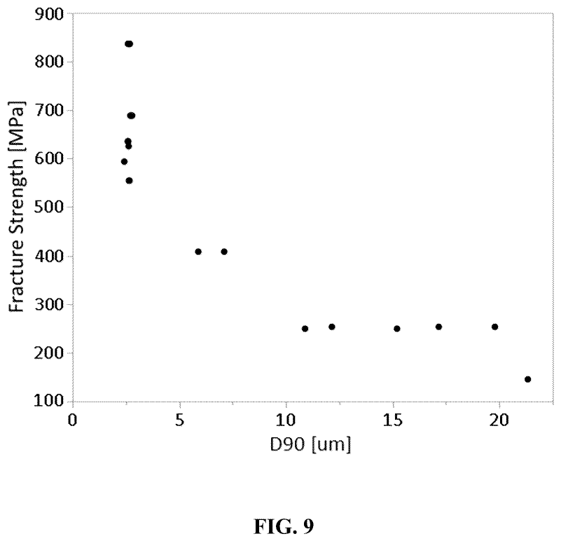

FIG. 9 shows a plot of fracture strength as determined by a ring-on-ring biaxial flexural strength test versus d₉₀ grain diameter as determined by quantitative SEM analysis of a surface of a tape-cast, sintered thin film separator. The variability in fracture strength is due to the fact that the weakest defect in a film will dictate the fracture strength. Nevertheless, the figure illustrates that high fracture strength can only be achieved for small grain size d₉₀ values. As used herein, the phrase “fracture strength,” refers to a measure of force required to break a material, e.g., a thin film electrolyte, by inducing a crack or fracture therein. Fracture strength values recited herein were measured using the ring on ring test. The ring-on-ring test is a measure of equibiaxial flexural strength and may be measured as specified in the ASTM C1499-09 standard. The test is performed at ambient temperature unless stated explicitly otherwise.

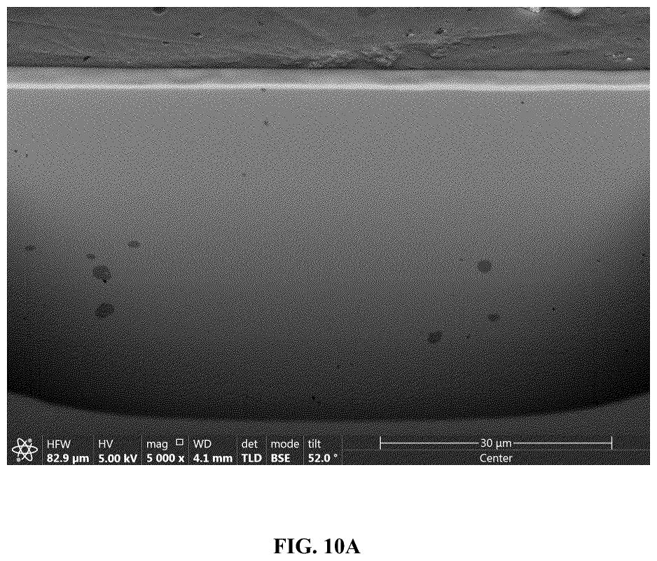

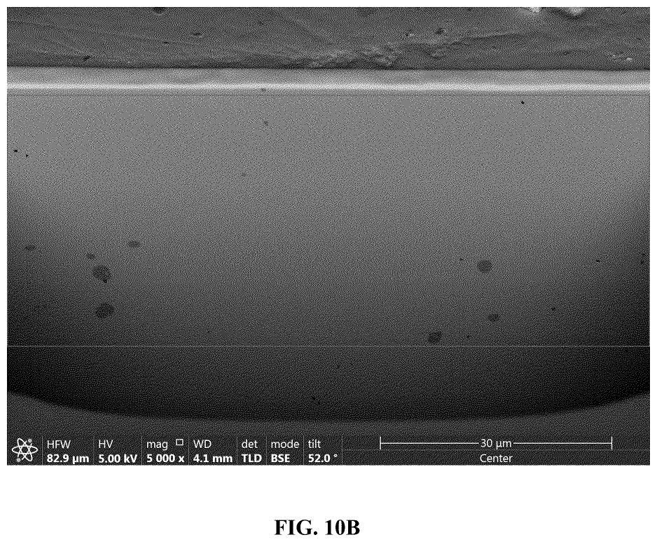

FIG. 10A shows a FIB cross-section image of a translucent and high density lithium-stuffed garnet separator, prepared according to Example 2. FIG. 10B shows the output of quantitative porosity determination for the image in FIG. 10A, showing a density of 99.95%.

### Example 5

A sample of LBHI was prepared by mixing the LiBH₄ and LiI in an inert vessel in a weight ratio of 1:1.5-2.5. Annealing was performed at 150-400° C. for 4-10 hours. A melt processed sample was created by taking the powder to above the melting point and pouring the melt into a mold and cooling slowly. A hot pressed sample was prepared by depositing mixed and calcined LBHI powder in a die, heating the die to below the melting point of LBHI, and applying pressure to the plungers over a time of 1-200 min.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1.-96. (canceled)

97. A Li⁺ ion-conducting separator,
wherein the Li⁺ ion-conducting separator:
is polycrystalline;
has a thickness from 10 nm to 1 mm;
comprises grains having a d₉₀ grain size ranging from 0.1 to 20 μm; and
has less than or equal to one defect per mm².

98. The Li⁺ ion-conducting separator of claim 97, wherein the Li⁺ ion-conducting separator has less than or equal to one defect per cm².

99. The Li⁺ ion-conducting separator of claim 97, wherein the Li⁺ ion-conducting separator has less than or equal to one defect per m².

100. The Li⁺ ion-conducting separator of claim 97, wherein the defect is a pore, a grain boundary, a dislocation, a crack, a separation, a chemical inhomogeneity, a phase segregation of two or more materials in a solid material, a pit, an inclusion, or a divot.

101. The Li⁺ ion-conducting separator of claim 100, wherein the defect is a pore.

102. The Li⁺ ion-conducting separator of claim 97, wherein the Li⁺ ion-conducting separator has a planar surface with substantially no pitting, inclusions, cracks, pores, or divots on the planar surface.

103. The Li⁺ ion-conducting separator of claim 97, wherein the Li⁺ ion-conducting separator has a surface roughness less than 5 μm.

104. The Li⁺ ion-conducting separator of claim 97, wherein the Li⁺ ion-conducting separator has a density ranging from 94%-99.9999% as measured by a 2D cross-section.

105. The Li⁺ ion-conducting separator of claim 97, wherein the Li⁺ ion-conducting separator comprises an oxide, a sulfide, a sulfide-halide, LIRAP, or a borohydride.

106. The Li⁺ ion-conducting separator of claim 105, wherein the Li⁺ ion-conducting separator comprises an oxide selected from a lithium-stuffed garnet characterized by the formula LiₓLa_{y}Zr_{z}Oₜ.qAl₂O₃, wherein 4<x<10, 1<y<4, 1<z<3, 6<t<14, 0≤q≤1.

107. The Li⁺ ion-conducting separator of claim 106, wherein the lithium-stuffed garnet is doped with Nb, Ga, Ta, or combinations thereof.

108. The Li⁺ ion-conducting separator of claim 106, wherein the lithium-stuffed garnet is characterized by the formula LiₐLa_{b}Zr_{c}Al_{d}Me″_{c}O_{f}, wherein 5<a<8.5; 2<b<4; 0<c≤2.5; 0≤d<2; 0≤e<2, and 10<f<13 and Me″ is a metal selected from Nb, Ga, Ta, or combinations thereof.

109. The Li⁺ ion-conducting separator of claim 106, wherein the lithium-stuffed garnet is characterized by the formula LiₓLa_{y}Zr_{z}Oₜ.0.11 (Al₂O₃), LiₓLa_{y}Zr_{z}Oₜ.0.22(Al₂O₃), LiₓLa_{y}Zr_{z}Oₜ.0.35(Al₂O₃), LiₓLa_{y}Zr_{z}Oₜ.0.5(Al₂O₃), LiₓLa_{y}Zr_{z}Oₜ.0.65(Al₂O₃), LiₓLa_{y}Zr_{z}Oₜ.0.75(Al₂O₃), or LiₓLa_{y}Zr_{z}Oₜ.(Al₂O₃), wherein 5<x<8.5.

110. The Li⁺ ion-conducting separator of claim 97, wherein the Li⁺ ion-conducting separator comprises:
a lithium-stuffed garnet oxide characterized by the formula LiᵤLaᵥZrₓO_{y}.zAl₂O₃, wherein
u is a rational number from 4 to 8;
v is a rational number from 2 to 4;
x is a rational number from 1 to 3;
y is a rational number from 10 to 14; and
z is a rational number from 0.05 to 1;
wherein u, v, x, y, and z are selected so that the lithium-stuffed garnet oxide is charge neutral.

111. The Li⁺ ion-conducting separator of claim 97, having a scattering center density that ranges from less than 1/m² to 1/mm².

112. The Li⁺ ion-conducting separator of claim 97, having a lithium-ion conductivity of greater than 10⁻⁴ S/cm at 25° C.

113. The Li⁺ ion-conducting separator of claim 97, having a lithium interfacial area-specific resistance of less than 20 Ωcm² at 25° C.

114. An electrochemical cell comprising a Li⁺ ion-conducting separator of claim 97.

115. The electrochemical cell of claim 114, wherein the electrochemical cell is a rechargeable battery.

116. A Li⁺ ion-conducting separator,
wherein the Li⁺ ion-conducting separator:
is polycrystalline;
has a thickness from 10 nm to 1 mm;
comprises grains having a d₉₀ grain size ranging from 0.1 to 20 μm; and
has a defect density of less than 10% by volume.

117. A Li⁺ ion-conducting separator,
wherein the Li⁺ ion-conducting separator:
is polycrystalline;
has a thickness from 10 nm to 1 mm;
comprises grains having a d₉₀ grain size ranging from 0.1 to 20 μm; and
has a geometric porosity of less than 5% by volume.
